(19) United States
(12) Patent Application Publication
(10) Pub. No.: US 2024/0059375 A1
(43) Pub. Date: Feb. 22, 2024

(54) POWER SYSTEMS FOR WATERCRAFT

(71) Applicant: Ride Awake AB, Stockholm (SE)

(72) Inventor: Philip WERNER, Stockholm (SE)

(73) Assignee: Ride Awake AB, Stockholm (SE)

(21) Appl. No.: 18/259,750

(22) PCT Filed: Dec. 22, 2021
(86) PCT No.: PCT/EP2021/087332

§ 371 Date: Jun. 28, 2023

(30) Foreign Application Priority Data
Dec. 28, 2020 (SE) 2051564-9

(51) Int. Cl. B63B 17/00; B63B 32/10; B63B 32/53; H01R 13/52; H01R 13/64; H01R 13/631; H01R 24/86; H01R 13/523

(52) U.S. Cl. CPC B63B 17/00; B63B 32/10; B63B 32/53; H01R 13/5219; H01R 13/64; H01R 13/631; H01R 13/521; H01R 24/86; H01R 13/523; H01R 2201/26

(57) ABSTRACT

An electrical connector system for a modular watercraft (100) comprising a first connector (302) comprising a plurality of electrically conductive pins (308, 310), and a second connector (402) comprising a plurality of electrically conductive female terminals (406, 408), wherein each electrically conductive pin (308, 310) and a corresponding one of electrically conductive female terminals (406, 408) are configured to mate when the first connector (302) and the second connector (402) are connected to each other to provide a respective electrically conductive connection, and the electrical connector system comprises at least one sealing means configured to provide a seal around at least one of the electrically conductive connections when the first connector (302) and the second connector (402) are connected to each other.

### TECHNICAL FIELD

The present invention relates to power systems. In particular, the invention relates to a power system for a watercraft, for example a modular electrically motor-driven watercraft having a driveline system. Present invention further relates to a method for controlling a watercraft.

### BACKGROUND

Only a small number of electrical watercrafts exist on the market. There exist different solutions on how the motor is mounted on the watercraft. Some are integrated, some are detachable. Furthermore, there exist different setups with integrated or detachable batteries.

A modular electrically motor-driven watercraft is described in WO 2019/129687. The watercraft provides a simple modular solution where the driveline system, hull and electronics system are independent parts. The driveline and electronics systems work together externally to the hull and can be used on different types of hull to form different watercraft. This vastly facilitates the assembly and maintenance of the watercraft. It also enables the possibility to customise the watercraft with easily different sizes of hull, propulsion units, and batteries. The watercraft may be a personal transportation, sports and/or leisure watercraft.

However, different watercraft have different power and propulsion requirements. For example, a jet ski operates in a different manner to an electric-powered surfboard. Therefore, it is desired to provide power systems for modular electrically motor-driven watercraft that are compatible with a number of different types of watercraft having different power and propulsion requirements.

### SUMMARY

The systems and methods disclosed herein provide improvements to modular watercraft currently known in the art. In particular, the present disclosure provides more flexible operation of a modular watercraft. The present disclosure also provides a modular watercraft that operates more safely. The present disclosure also provides a modular watercraft that operates more efficiently.

In particular, a number of modules are provided comprising electrical connectors that are able to operate underwater without the risk of a short circuit between the connections. The module can be disconnected and reconnected underwater. This is enabled by providing a number of sealed connections between pins of the electrical connectors. This provides more flexible operation of a watercraft, as batteries can be changed while the craft is at least partially submerged.

A control system of the watercraft enables different parameters and conditions of the modules of the watercraft to be monitored, and appropriate action to be taken to enable safe operation. For example, certain parameters can be monitored to ensure that it is safe to activate the electrical components of the watercraft. This can be performed prior to start-up, and can be monitored throughout operation of the watercraft.

The control system also enables different parameters and conditions of the modules of the watercraft to be monitored, and appropriate action to be taken to enable efficient operation. For example, certain parameters can be monitored and a maximum speed of the watercraft can be determined based on these parameters. This can ensure that components of the watercraft are operated safely and efficiently. These parameters can be monitored throughout operation of the watercraft and the maximum speed can be adjusted accordingly.

According to an aspect, there is provided an electrical connector system for a modular watercraft comprising a first connector comprising a plurality of electrically conductive pins, and a second connector comprising a plurality of electrically conductive female terminals, wherein each electrically conductive pin and a corresponding one of electrically conductive female terminals are configured to mate when the first connector and the second connector are connected to each other to provide a respective electrically conductive connection, and the electrical connector system comprises at least one sealing means configured to provide a seal around a subset of the electrically conductive connections when the first connector and the second connector are connected to each other.

Optionally, the sealing means comprises at least one O-ring disposed in one of the first connector and the second connector, and at least one channel disposed in the second connector, wherein the O-ring and the channel are configured to interact and provide the seal when the first and second connectors are connected to each other. Optionally, a respective O-ring is disposed around each of the plurality of electrically conductive pins and a respective channel is disposed around each of the plurality of electrically conductive female terminals.

Optionally, the electrically conductive connections are configured to transfer power and/or data between the first connector and the second connector.

Optionally, the electrical connector system is configured to transfer power and data between the first connector and the second connector.

Optionally, the plurality of electrically conductive pins comprises a first set of electrically conductive pins and a second set of electrically conductive pins, the plurality of electrically conductive female terminals comprises a first set of electrically conductive female terminals and a second set of electrically conductive female terminals, each of the first set of electrically conductive pins and a corresponding one of the first set of electrically conductive female terminals are configured to provide a respective first electrically conductive connection when the first connector and the second connector are connected to each other, each of the second set of electrically conductive pins and a corresponding one of the second set of electrically conductive female terminals are configured to provide a respective second electrically conductive connection when the first connector and the second connector are connected to each other, the first electrically conductive connections are configured to transfer power between the first connector and the second connector, and the second electrically conductive connections are configured to transfer data between the first connector and the second connector.

Optionally, the first connector and the second connector are configured to provide a blind mate connection with each other. Optionally, the first connector and the second connector are configured to provide a mechanical connection. Optionally, the mechanical connection is a releasable mechanical connection.

Optionally, one of the first connector and the second connector is coupled to a driveline module of the modular watercraft and the other of the first connector and the second connector is coupled to an electric power module of the modular watercraft. Optionally, the first connector or the second connector is disposed in an interface module of the driveline module. Optionally, the first or the second connector is disposed in a battery module of the electric power module.

Optionally, the first connector is coupled to a driveline module of the modular watercraft, and the second connector is coupled to an electric power module of the modular watercraft. Optionally, the first connector is disposed in an interface module of the driveline module. Optionally, the second connector is disposed in a battery module of the electric power module.

According to another aspect, there is provided a driveline system for a modular watercraft comprising a driveline module comprising propulsion means for the watercraft, the driveline module comprising the first connector, an electric power module comprising a power source for the driveline module, the electric power module comprises the first connector or second connector.

According to another aspect, there is provided a driveline system for a modular watercraft comprising a driveline module comprising propulsion means for the watercraft, the driveline module comprising the first connector, an electric power module comprising a power source for the driveline module, the electric power module comprises the second connector.

According to another aspect, there is provided a modular watercraft comprising a hull module comprising a hull of a hydrofoiling watercraft, hydroplane, surfboard, jet ski, water scooter, inflatable craft, overwater drone, underwater drone, submarine, or boat and, the driveline system.

Optionally, the hull module comprises a through hole adapted to receive the first connector and/or the second connector. Optionally, the through hole is configured to allow water to pass through during operation of the watercraft in order to cool at least part of the driveline module and/or electric power module.

According to another aspect, there is provided an interface module for a driveline module of a modular watercraft, the interface module comprising at least one connector configured to provide a plurality of electrically conductive connections to a second module of the modular watercraft, wherein the plurality of electrically conductive connections is configured to transfer power and/or data between the interface module and the second module, and the at least one connector comprises at least one first sealing means configured to provide a seal around a subset of the electrically conductive connections when the connector is connected to the second module.

Optionally, the sealing means comprises at least one O-ring disposed in the connector and configured to interact with at least one corresponding channel of the second module and provide the seal when the connector is connected to the second module. Optionally, the connector comprises a plurality of electrically conductive pins configured to mate with a corresponding plurality of electrically conductive female terminals of the second module to provide the plurality of electrically conductive connections between the interface module and the second module when the connector is connected to the second module. Optionally, the plurality of electrically conductive pins comprises a first set of electrically conductive pins configured to transfer power between the interface module and the second module, and a second set of electrically conductive pins configured to transfer data between the interface module and the second module. Optionally, a respective O-ring is disposed around each of the plurality of electrically conductive pins and configured to interact with at least one corresponding channel of the second module and provide the seal when the connector is connected to the second module.

Optionally, the second module is an electric power module or a motor unit of the modular watercraft. Optionally, the at least one connector comprises a first connector configured to provide at least one electrically conductive connection to an electric power module of the modular watercraft, and a second connector configured to provide at least one electrically conductive connection to a motor unit of the modular watercraft.

According to another aspect, there is provided a battery module for a modular watercraft, the battery module comprising a housing comprising an electrical power source, and a connector disposed on the housing and configured to provide a plurality of electrically conductive connections to a driveline module of the modular watercraft, wherein the plurality of electrically conductive connections is configured to transfer power between the electrical power source and the driveline module, and the at connector comprises at least one first sealing means configured to provide a seal around a subset of the electrically conductive connections when the connector is connected to the driveline module.

Optionally, the sealing means comprises at least one channel disposed in the connector and configured to interact with at least one corresponding O-ring of the driveline module and provide the seal when the connector is connected to the driveline module. Optionally, the connector comprises a plurality of electrically conductive female terminals configured to mate with a corresponding plurality of electrically conductive pins of the driveline module to provide the plurality of electrically conductive connections between the battery module and the driveline module when the connector is connected to the driveline module. Optionally, the plurality of electrically conductive female terminals comprises a first set of electrically conductive female terminals configured to transfer power between the battery module and the driveline module, and a second set of electrically conductive female terminals configured to transfer data between the battery module and the driveline module. Optionally, a respective channel is disposed around each of the plurality of electrically conductive female terminals and configured to interact with at least one corresponding O-ring of the driveline module and provide the seal when the connector is connected to the driveline module.

Optionally, the electrical power source comprises one or more electrochemical cells configured to store energy. Optionally, the electrochemical cells are rechargeable. Optionally, the battery module further comprises a heat-conducting material disposed between the electrochemical cells and the housing. Optionally, the battery module further comprises a second connector configured to provide an electrical connection between the battery module and another battery module.

According to an aspect, there is provided a control system for a modular watercraft comprising a driveline module an electric power module, the control system comprises a control unit and one or more sensors disposed in the modular watercraft, the one or more sensors being communicatively coupled to the control unit and configured to detect one or more parameters relating to the modular watercraft, wherein the control unit is configured to receive information from the one or more sensors and generate a control signal for the driveline module and/or electric power module based on the received information.

Optionally, the watercraft may be a non-modular watercraft.

Optionally, the control unit is disposed in the driveline module or the electric power module.

Optionally, the one or more sensors are disposed in the driveline module or the electric power module. Optionally, the one or more sensors are configured to detect one or more parameters relating to the driveline module or the electric power module

Optionally, there is provided a control system for a modular watercraft comprising a driveline module and an electric power module, the control system comprising a control unit disposed in the driveline module or the electric power module, and one or more sensors disposed in the driveline system or the electric power module, the one or more sensors being communicatively coupled to the control unit and configured to detect one more parameters relating to the driveline module or the electric power module, wherein the control unit is configured to receive information from the one or more sensors and generate a control signal for the driveline module and/or the electric power module based on the received information.

Optionally, the one or more sensors comprise at least one of one or more temperature sensors, one or more moisture sensors, one or more pressure sensors, one or more gyroscopes, one or more magnetic field sensors, one or more watercraft speed sensors, one or more driveline speed sensors, one or more driveline torque sensors and a voltage sensor. Optionally, the one or more temperature sensors is configured to detect the temperature in a connection between the driveline module and the electric power module. Optionally, the one or more moisture sensors is configured to detect moisture in a connection between the driveline module and the electric power module. Optionally, the one or more pressure sensors is configured to detect a pressure indicative of a depth of the driveline module or the electric power module. Optionally, the one or more gyroscopes sensors is configured to detect an orientation of the driveline module, the watercraft or the electric power module.

Optionally, the control system further comprises one or more magnets, wherein the one or more magnetic field sensors are configured to detect a magnetic field from a corresponding magnet. Optionally, the one or more magnetic field sensors are disposed in the driveline module, and the one or more magnets are disposed in the electric power module. Optionally, the one or more magnetic field sensors are disposed in the electric power module, and the one or more magnets are disposed in the driveline module. Optionally, the voltage sensor is configured to determine a voltage level of a power source in the electric power module. Optionally, the one or more watercraft speed sensors is configured to determine the speed of the modular watercraft. Optionally, the one or more driveline speed sensors are configured to determine the speed at which the driveline module operates. Optionally, the one or more motor torque sensors are configured to determine the torque provided by the driveline module.

Optionally, the control unit is disposed in the driveline module. Optionally, the control unit is disposed in the electric power module. Optionally, the control signal includes an instruction relating to activation of the electric power module. Optionally, the control signal includes a speed limit for operation of the driveline module. Optionally, the control unit is configured to provide the control signal to an electronic speed controller of the driveline module.

According to an aspect, a modular watercraft is provided. The modular watercraft comprises propulsion means for the modular watercraft, an electric power module for driving the propulsion means, a hull module and a control system according to any of the above embodiments.

Optionally, the hull module comprises a hull of a hydrofoiling watercraft, hydroplane, surfboard, jet ski, water scooter, inflatable craft, overwater drone, underwater drone, submarine, or boat.

Optionally, the propulsion means is mounted to a mast extending from a bottom surface of the hull module to form a hydrofoil watercraft.

According to another aspect, there is provided a method for controlling activation of a driveline system of a modular watercraft, wherein the driveline system comprises a driveline module and an electric power module, the method the method performed by a control unit of the modular watercraft and comprising determining if one or more conditions for activation of the driveline system have been met, if it is determined that the conditions for activation of the driveline system have been met, providing instructions enabling activation of the driveline module.

Optionally, determining if one or more conditions for activation of the driveline system have been met comprises at least one of determining a temperature in the driveline system and comparing the determined temperature to at least one temperature threshold, determining a moisture level in the driveline system and comparing the determined moisture level to at least one moisture threshold, determining a pressure of the driveline system and comparing the determined pressure to at least one pressure threshold, determining an orientation of the driveline system and comparing the determined orientation to desired orientation, determining a proximity between the driveline module and the electric power module and comparing the determined proximity to at least one proximity threshold, and determining a voltage level of a power source in the electric power module and comparing the determined voltage level to at least one voltage threshold.

Optionally, the method further comprises, if it is determined that one or more of the conditions for activation of the driveline system has not been met, providing instructions prohibiting activation of the driveline system or shutting down the driveline system. Optionally, the method further comprises, if it is determined that one or more of the conditions for activation of the driveline system has not been met, issuing an alert indicating that the driveline system should not be activated or should be shut down.

Optionally, the method is performed before start-up of the driveline module. Optionally, the method is performed during operation of the driveline module. Optionally, the control unit is disposed in the driveline module or the electric power module.

According to another aspect, there is provided a method for controlling operation of a watercraft. The watercraft comprises a hull module, a driveline module and an electric power module, the method performed by a control unit of the watercraft and comprising determining at least one operating condition of the watercraft, determining a target speed, acceleration and/or power for the modular watercraft based on the at least one determined operating condition and generating a control signal for the driveline module based on said target speed, acceleration and/or power.

Optionally, the control signal indicates said target speed, acceleration and/or power at which the driveline module may operate.

Optionally, the watercraft is a modular watercraft. The modular watercraft may be a modular watercraft according to any one of the above described embodiments.

Optionally, determining the at least one operating condition includes at least one of determining the type of the hull module, determining the depth of the modular watercraft, determining the depth of the watercraft, determining the number of batteries, determining the speed at which the driveline module operates, determining the orientation of the watercraft, determining the torque provided by the driveline module and determining the speed of the watercraft.

Optionally, the method further comprises determining a maximum speed and/or power for the watercraft based on the at least one determined operating condition and generating a control signal for the driveline module indicating a maximum speed and/or power at which the driveline module may operate.

Optionally, there is provided a method for controlling operation of a modular watercraft, wherein the modular watercraft comprises a hull module, a driveline module and an electric power module, the method performed by a control unit of the modular watercraft and comprising determining at least one operating condition of the watercraft, including at least one of determining the type of the hull module, determining the depth of modular watercraft, determining the number of batteries in the electric power module, and determining a level of charge remaining in the batteries, determining a maximum speed for the modular watercraft based on the at least one determined operating condition, generating a control signal for the driveline module indicating a maximum speed and/or power at which the driveline module may operate.

Optionally, the type of hull module is determined based on a user input to the watercraft. Optionally, the depth of modular watercraft is determined based on a signal received from a pressure sensor disposed in the modular watercraft. Optionally, the number of batteries in the electric power module is determined based on a signal received from the electric power module. Optionally, the level of charge remaining in the batteries is determined based on a signal received from the electric power module. Optionally, the speed of the watercraft is determined based on a signal received from a watercraft speed sensor disposed in the watercraft. Optionally, the speed at which the driveline module operates is determined based on a signal received from a driveline speed sensor disposed in the driveline module. Optionally, the torque provided by the driveline module is determined based on a signal received from a driveline torque sensor disposed in the driveline module.

Optionally, the target power is based at least on the speed of the watercraft and the speed at which the driveline module operates. Optionally, the target acceleration is based at least on the speed of the watercraft and the speed at which the driveline module operates. Optionally, the target acceleration is based at least on the torque provided by the driveline module. Optionally, the orientation of the watercraft is based on a signal received from a gyroscope disposed on the watercraft. Optionally, the target speed is based at least on the orientation of the watercraft.

Optionally, the method further comprises, transmitting the control signal to an electronic speed controller of the driveline module. Optionally, the control unit is disposed in the driveline module or the electric power module.

According to another aspect, a watercraft is provided. The watercraft comprises a hull module, a driveline module, an electrical power module and a control unit. The control unit is operatively coupled to said driveline module and electrical power module, control unit being configured to perform the method according to above described embodiments. The control unit may be configured to control the speed, acceleration and/or power at which the driveline module may operate based on the control signal.

### BRIEF DESCRIPTION OF DRAWINGS

Exemplary embodiments of the will be described in further detail below in the shape of non-limiting examples and with reference to the accompanying drawings, in which:

FIG. 1 shows an exploded view of an exemplary modular watercraft;

FIG. 2 shows a view of an exemplary assembled driveline system;

FIG. 3 shows an exemplary interface module;

FIG. 4 shows a plan view of an exemplary first connector of an interface module;

FIG. 5 shows a front view of an exemplary second connector of an interface module;

FIG. 6 shows an exemplary battery module;

FIG. 7 shows a plan view of an exemplary connector of a battery module;

FIGS. 8A and 8B illustrate an exemplary watercraft in the form of a jet ski;

FIGS. 9A and 9B illustrate an exemplary watercraft in the form of a boat;

FIGS. 10A and 10B illustrates an exemplary watercraft in the form of a hydrofoiling watercraft;

FIGS. 11A and 11B illustrates an exemplary watercraft in the form of a personal underwater craft.

FIG. 12 shows a schematic view of control components of an exemplary interface module;

FIG. 13 shows a schematic view of control components of an exemplary battery module;

FIG. 14 is a flow chart illustrating an exemplary method for controlling activation of a driveline system and/or watercraft;

FIG. 15 is a flow chart illustrating an exemplary method for controlling the speed and/or power of a driveline system and/or watercraft;

FIG. 16 is a flow chart illustrating an embodiment of the exemplary method for controlling the speed and/or power of a driveline system and/or watercraft; and

FIG. 17 is a block diagram illustrating an exemplary computer system.

Throughout the description and the drawings, like reference numerals refer to like parts.

### DETAILED DESCRIPTION

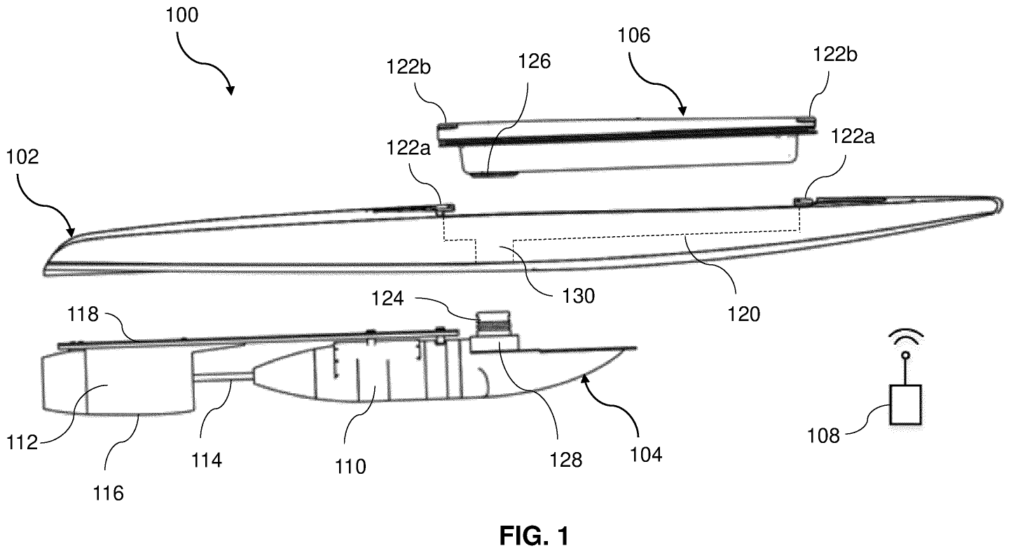

FIG. 1 shows an exploded view of a modular watercraft 100, as also disclosed in WO2019129687A1. The watercraft 100 comprises a hull module 102, a driveline module 104, and an electric power module 106. The driveline module 104 is configured to provide propulsion for the watercraft 100. The electric power module 106 is configured to provide power to the driveline module 104. The driveline module 104 and the electric power module 106 are connectable to the hull module 102 and operable to propel the watercraft 100.

The watercraft 100 is constructed by assembling at least one hull module 102, at least one driveline module 104, and at least one electric power module 106 together in a modular fashion. The hull module 102, the driveline module 104, and the electric power module 106 are independent modules. This facilitates the assembly and maintenance of the watercraft 100. Whilst a single one of each module is shown in FIG. 1, it will be appreciated that different numbers of modules can be assembled to provide different watercraft, as will be explained below.

The watercraft 100 may be suitable for personal transport, sport or leisure. For example, a user may stand on the board or lay down on the watercraft 100 during operation. The watercraft 100 may be controlled by various means such as a speed control disposed on the electric power module 106 and/or on the driveline module 104. The watercraft 100 may also be controlled via remote control, for example by means of a remote control unit 108. As such, in one example, the user may lay down on the board and control the watercraft 100 by operating the remote control unit 108. The remote control unit 108 may be, for example, a smartphone, computer, or other portable unit suitable for controlling the watercraft.

In FIG. 1, the hull module 102 of the watercraft 100 is in the form of a board. Whilst the hull module 102 is in the form of a board in FIG. 1, the driveline module 104 and the electric power module 106 are compatible with other types of hull module 102 to provide other types of watercraft 100. For example, the hull module 102 may comprise a hull of a hydrofoiling watercraft, hydroplane, surfboard, jet ski/water scooter, inflatable craft, overwater drone, underwater drone, submarine, or boat.

The hull module 102 is fluid tight or waterproof. In this particular implementation, the board itself is also buoyant on its own merit and may comprise an empty shell-type hull. In some implementations, the hull module 102 is independently waterproof or hermetically sealed. Thus, the hull module 102 may be buoyant regardless its orientation in relation to water. In some implementations, the hull module 102 may not be buoyant, for example if the watercraft is an underwater craft.

The driveline module 104 is adapted to be submerged in fluid, such as water, during operation of the watercraft 100, i.e. when the watercraft 100 is launched into water. The driveline module 104 may therefore be adapted to be attached to a bottom external surface of the hull module 102. The driveline module 104 is assembled on the hull module 102 in order to provide a propelling force in a forward direction of the hull module 102. In some implementations, the driveline module 104 is assembled towards the rear end of the hull module.

The driveline module 104 comprises at least one motor unit 110 in driving connection with at least one propelling member 112 via at least one drive shaft 114. The propelling member 112 may, for example, comprise one or more propellers. In one example, the propelling member 112 is an impeller of a water jet arrangement, as known in the art. The driveline module 104 may comprise a waterproof casing or pod 116 surrounding the propelling member 112. The motor unit 110 and the casing 116 are respectively attached to a hull connection 118, which maintains the positions of the motor unit 110 and the casing 116 in relation to each other. Thus, the motor unit 110 and the casing 116 are not in direct contact with each other.

In some implementations, the driveline module 104 comprises struts and hydrofoil-wings that enable the watercraft 100 to lift over the water to some extent. This enables the watercraft 100 to ride over the water and therefore produce less drag, which can decrease the energy-consumption of the watercraft 100 and increase the speed of the watercraft 100.

The electric power module 106 comprises an energy source and electronics for operation of the watercraft 100. This may include one or more battery modules, a computer, a battery management system, switches etc. The electric power module 106 provides power to the driveline module 104 in order to operate the watercraft 100. The electric power module 106 can be made from any suitable material, for example heat-transferring materials such as aluminium and stainless well and/or other materials such as carbon fibre, plastics and the like. The electric power module 106 may be activated in a number of ways. For example, the electric power module 106 may comprise an on/off switch, which is actioned in order to turn the electric power module 106 on or off.

The driveline module 104 and the electric power module 106 may be detachably attached on opposite sides of the hull module 102. This facilitates that the driveline module 104 and/or the power module 106 can easily be switched out for another module, without pivoting or turning the hull module 102, for example when floating on water. For example, the electric power module 106 can be replaced when the batteries are depleted.

The hull module 102 comprises means for receiving the electric power module 106 facilitating that the electric power module 106 is safely received and retained in the hull module 102 without risk of dislodging during operation of the watercraft 100. In the implementation of FIG. 1, this is in the form of an open, shelf-like compartment 120. The compartment 120 constitutes an external surface of the hull module 102 that may abut the electric power module 106. Preferably, the electric power module 106 comprises a shape corresponding to an external surface of the watercraft such that it is disposed flush with an upper surface of the hull module 102 when the electric power received in the hull module 102. Attachment means 122a-b may be provided in the hull module 102 and/or on the electric power module 106 for detachable attachment of the electric power module 106 to the hull module 102. The attachment means 122a-b may comprise releasable attachment means, such as a snap-in function. In some implementations, the compartment 120 is configured to allow water to flow in even when the power module 106 is installed. This allows the electric power module 106 to be at least partially submerged in water during operation for cooling purposes.

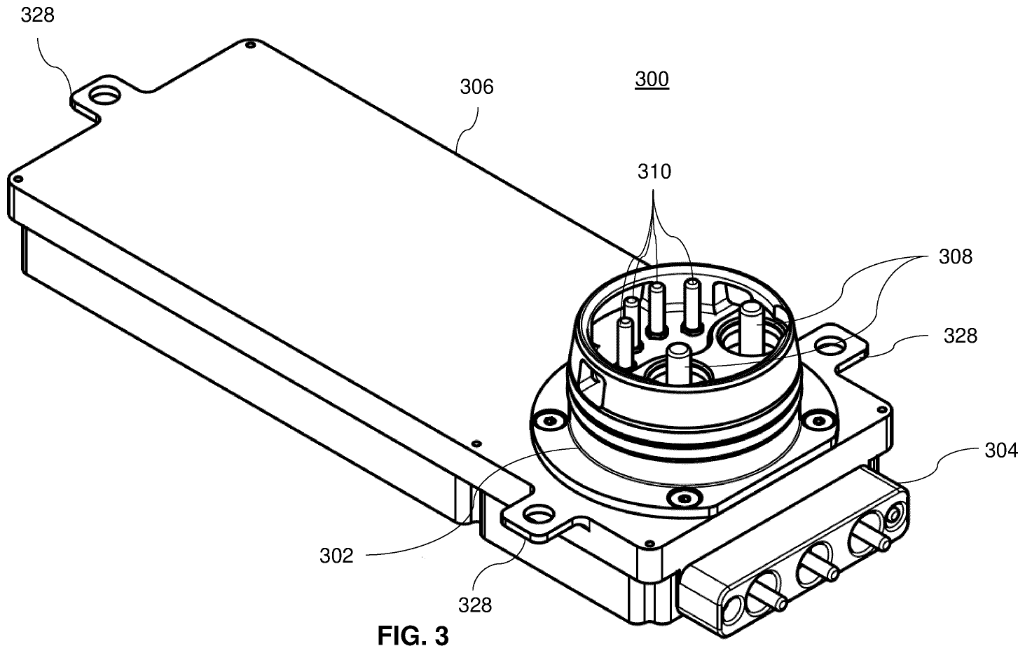

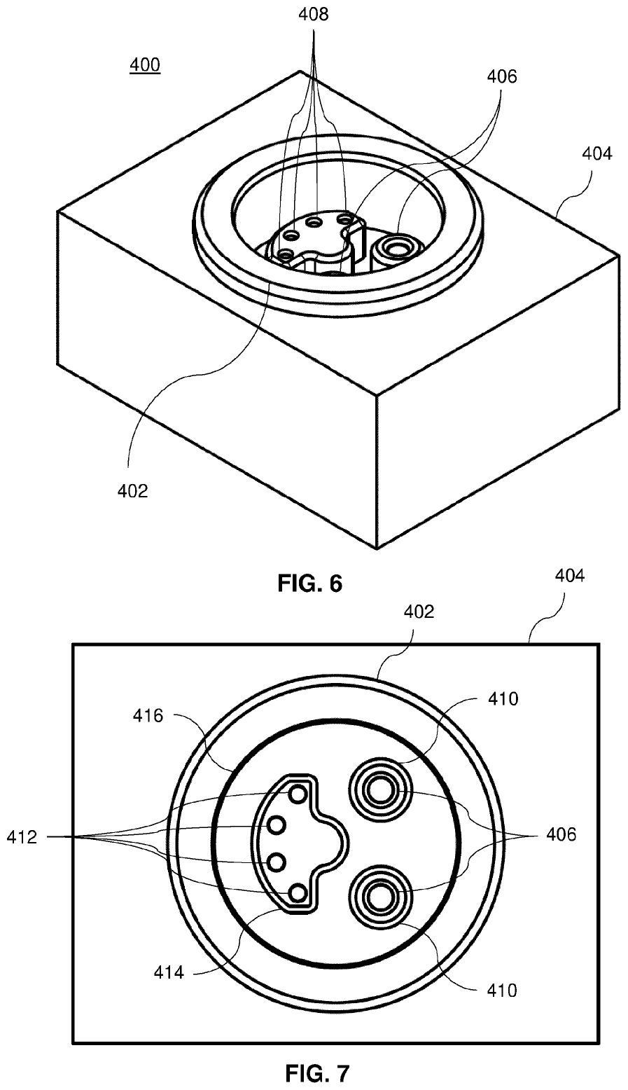

When the hull module 102, the driveline module 104, and the electric power module 106 are assembled to form the watercraft 100, the driveline module 104 and the electric power module 106 should be coupled in order to transfer power from the electric power module 106 to the driveline module 104. As such, the driveline module 104 comprises a connector 124 and the electric power module 106 comprises a corresponding connector 126. In one example, the connector 124 is present on an interface module 128 of the driveline module 104, as will be explained in more detail in relation to FIGS. 3 to 5. In one example, the connector 126 is present on a battery module of the electric power module 106, as will be explained in more detail in relation to FIGS. 6 and 7. In some implementations, the connectors 124, 126 are adapted to transfer both power and data between the driveline module 104 and the electric power module 106.

The connectors 124, 126 allow the driveline module 104 to be connected to the electric power module 106. The connectors 124, 126 are configured to establish an electrical connection with each other. The connectors 124, 126 are arranged as a plug-socket arrangement. This has the advantage that there are no electrical wires extending between the electrical power module 106 and the driveline module 104.

In some implementations, the connectors 124, 126 are configured to establish a mechanical connection, preferably a releasable mechanical connection, with each other. The mechanical connection may physically connect and hold the driveline module 104 and the electric power module 106 together. For example, the connectors 124, 126 may comprise a suitable type of locking mechanism, such as a snap-in function, or mechanical lock/hinge to retain them in contact when they are attached. The mechanical connection established by the connectors 124, 126 may be waterproof. In some implementations, the connectors 124, 126 form a blind mate connection.

In order to facilitate the connection between the driveline module 104 and the electric power module 106, the hull module 102 may also comprise a through hole 130 that extends through the hull module 102. The through hole 130 may extend from an upper side of the hull module 102 to a lower side of the hull module 102. The inner surface of through hole 130 constitutes an external surface of hull module 102 such that no water is allowed to enter the hull module 102. The through hole 130 may be formed away from the edges of the hull module 102, preferably substantially at a transversally centred position of the hull module 102. Thus, the through hole 130 comprises a circumferential rim and the hull module 102 extends continuously around the through hole 130.

In some implementations, the through hole 130 is adapted to receive the connector 124 of the driveline module 104. As such, the connector 124 may extend upwards from the driveline module 104 and into or through the hull module 102. In other implementations, the connector 126 of the electric power module 106 may extend into or through the hull module 102 via the through hole 130. In some implementations, both the connector 124 of the driveline module 104 and the connector 126 of the electric power module 106 may extend at least partially into the through hole 130.

At a top side, the through hole 130 opens to and/or is in fluid communication with the compartment 120. At a bottom side, the through hole 130 opens to point below the hull module 102 of the watercraft 100. The through hole 130 preferably has a diameter sized to form a circumferential slot about the connectors 124, 126. In this way, a fluid passage is formed between the inner circumference of the through hole 130 and the outer sides of the connectors 124, 126. The through hole 130 therefore fluidly connects an upper side of the hull module 102 to a lower side of the hull module 102 during operation of the watercraft 100. In operation, water that flows into the compartment 120 is allowed drain through the hull module 102 via the through hole 130. Hence, the connectors 124, 126 and the driveline module 104 (including the motor unit 110) may be passively water-cooled. The through hole 130 further facilitates that, when the watercraft is in operation, water is pushed upwards from beneath the hull module 102, through the through hole 130 to the compartment 120, and thereby cools the electric power module 106. The electric power module 106 may also comprise a mechanical cooling system in some implementations. This means that the electric power module 106 can include an active cooling system as well as be passively cooled by natural convection.

In some implementations, the hull module 102 may comprise a plurality of through holes 130. Each through hole 130 may receive a respective pair of connectors 124, 126 such that a plurality of driveline modules 104 or electric power modules 106 can be connected to the hull module 102. In some implementations, a single driveline module 104 or electric power module 106 may have a plurality of connectors 124, 126, for example in a plurality of submodules. In this way, a number of different configurations of driveline modules 104 and electric power modules 106 are possible fora given hull module 102.

It will be appreciated that other types of hull module 102 may have different configurations of through holes 130 to provide the cooling effects discussed above. For example, a hull module 102 of a jet ski or boat may have one or more holes in a front portion of the hull module 102 to allow water to enter as the watercraft 100 moves through the water. The hull module 102 may comprise a drain towards a rear end configured to maintain the water level passing through the hull module 102 no higher than that required for cooling. In other implementations, a hose may be connected to the water jet that routes water to the components that require cooling.

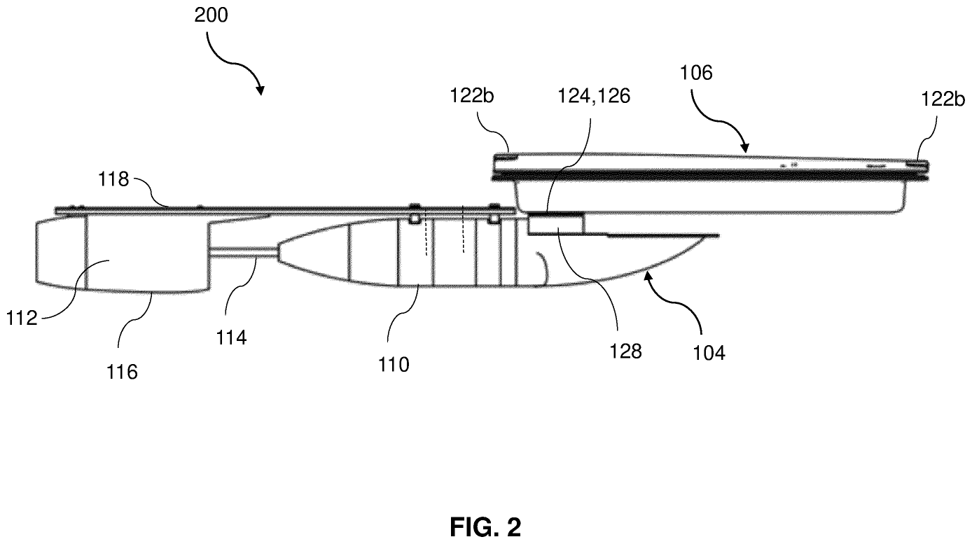

The driveline module 104 and the electric power module 106 form a driveline system 200, shown in FIG. 2). The driveline system 200 can operate independently of the hull module 102. That is to say that that the driveline system 200 is self-sustained in terms of providing a functioning driveline, i.e., comprising a power supply in the form of the electric power module 106 and power transformation to kinetic energy by means of the driveline module 104. The driveline system 200 is compatible with a number of different types of hull module 102. This enables simple customisation of the watercraft 100 with different types of hull, propulsion, batteries and motors, to provide different types of watercraft 100.

FIG. 2 shows the driveline system 200 comprising the driveline module 104 and the electric power module 106 of FIG. 1 when the driveline module 104 and the electric power module 106 are connected using the connectors 124, 126. All components essential for the propulsion of the watercraft 100 are integrated into the driveline system 200. As discussed above, the electric power module 106 comprises an energy source and provides power to the driveline module 104 in order to operate the watercraft 100. In some implementations, the energy source includes one or more battery modules. An example battery module is described in relation to FIGS. 6 and 7.

The driveline system 200, when assembled, is waterproof. Further, the electric power module 106 and the driveline module 104 may each be individually waterproof. This has the advantage that the driveline system 200 can operate externally to the hull module 102 during operation of the watercraft 100. Thus, the hull module 102 may comprise only a dead shell.

In some implementations, the driveline system 200 may comprise one or more proximity sensing systems that detect the proximity between the electric power module 106 and the driveline module 104. When the proximity is deemed to meet a certain threshold, indicating that the driveline module 104 and the electric power module 106 are properly coupled, a signal can be issued which enables activation of the electric power module 106. The proximity sensing systems can also be used to determine the orientation of the driveline module 104 relative to the electric power module 106.

The driveline system 200 may comprise an electronic speed controller (ESC, not shown). The ESC may be implemented in the driveline module 104, the electric power module 106 or other part of the watercraft 100. The ESC is configured to control the operation of the driveline module 104, and in particular the motor unit 110. The ESC may be provided in the form of a sub-module of the driveline module 104 or the electric power module 106. The ESC sub-module may be connected to the driveline module 104 or the electric power module 106 by means of a waterproof connection, which may comprise a waterproof plug-socket arrangement.

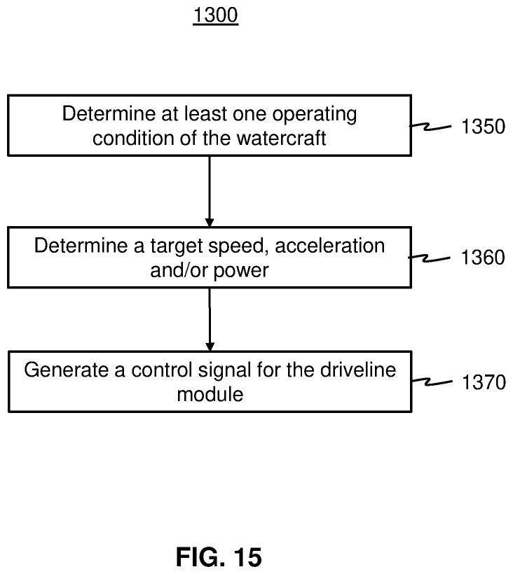

The ESC is operable to control the speed of the motor unit 110 based on one or more parameters. For example, the watercraft 100 may comprise a throttle that is operated by a user, where the ESC is connected between the throttle and the motor unit 110. The ESC may receive instructions from a control unit of the driveline module 104 or the electric power module 106 that sets limits on the speed that can be attained by the motor unit 110. This will be explained in more detail in relation to FIG. 15. In some implementations, a steering system could be coupled to the throttle and/or the ESC if it is desired to steer the watercraft via controlling the operating speed of the driveline module 104.

The ESC may be connected in a wired or wireless manner to the throttle. In some implementations, the throttle is operatively connected via a wired connection to an ESC sub-module in the driveline module 104 or the electric power module 106. In some implementations, the ESC is operatively connected to the remote control unit 108 is and can be controlled by the remote control unit 108. In some implementations, the remote control unit 108 may be operatively connected to the ESC via a communication unit. The communication unit may be disposed on the driveline module 104 or the electric power module 106. The communication unit may be powered by means of the electric power module 106.

In some implementations, the ESC is disposed in the interface module 128, or another portion of the driveline module 104 positioned vertically directly underneath the through hole 130 or in a position allowing cooling water to surround the ESC. This has the effect that the ESC will be passively cooled by means of water flowing from the through hole 130 during operation.

FIG. 3 shows an interface module 300, which is an example of the interface module 128 shown in FIGS. 1 and 2. The interface module 300 may be a sub-module of the driveline module 104. The interface module 300 comprises a first connector 302 (for example, the connector 124 shown in FIG. 1) for connection to an electric power module 106. The interface module 300 comprises a second connector 304 for connection to a motor unit, such as the motor unit 110 shown in FIG. 1 or the ESC discussed above. The interface module 300 also comprises a housing 306.

The first connector 302 comprises a first set of electrically conductive pins 308 for receiving power transmitted from the electric power module 106. In the example of FIG. 3, two power pins 308 are shown, but it will be appreciated that more than two power pins may be implemented. The first connector 302 may also comprise a second set of electrically conductive pins 310 for receiving data from and transmitting data to the electric power module 106. In the example of FIG. 3, four data pins 310 are shown, but the first connector could be implemented with two or more data pins.

The second connector 304 comprises a first set of electrically conductive pins 320 for transmitting power to the motor unit 110. The second connector 304 comprises three power pins 320 in order to provide three phase current to the motor unit or the ESC. The first connector 302 may also comprise a second set of electrically conductive pins 322 for receiving data from and transmitting data to the motor unit 110. In the example of FIG. 3, two data pins 322 are shown, but it will be appreciated that more than two data pins may be implemented.

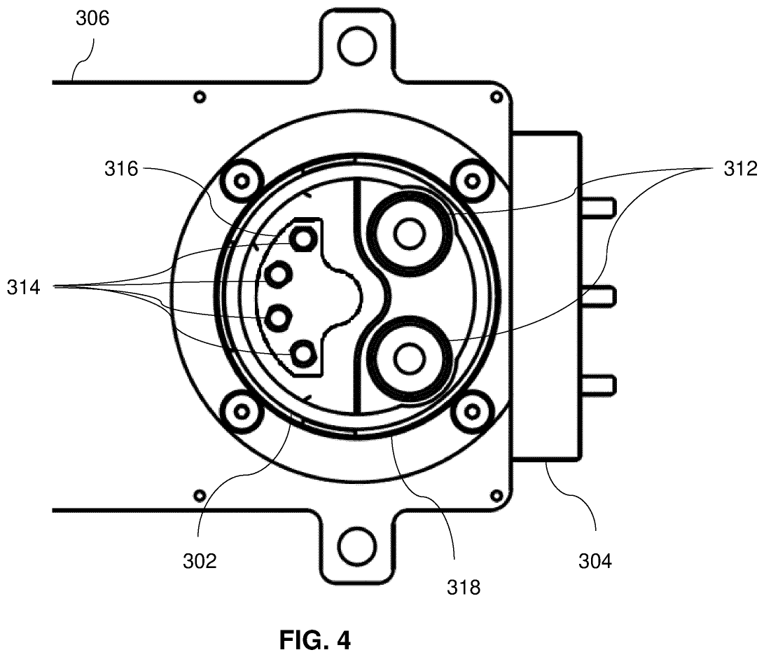

FIG. 4 shows a plan view of the first connector 302 in the interface module 300. The first and second sets of pins 308, 310 are not numbered in FIG. 4 to enable the figure to be read clearly. The first connector 302 is provided with a number of sealing means in order to provide a seal around electrically active components of the first connector 302. In the example of FIG. 4, each of the power pins 308 may have one or more respective O-rings 312 in order to provide a seal around each power pin 308 when the first connector 302 is connected. Each of the data pins 310 may have one or more respective O-rings 314 in order to provide a seal around each data pin 310 when the first connector 302 is connected. The first connector 302 may also have one or more O-rings 316 that encircles the data pins to provide a seal around the data pins 310 when the first connector 302 is connected. The first connector 302 may also have one or more O-rings 318 to provide a seal around the first connector 302 when the first connector 302 is connected. The first connector 302 may have any combination of O-rings 312, 314, 316 and 318 that seal the pins 308, 310 from the outside. For example, the first connector 302 may have only O-rings 312 and 314, or only O-ring 318. In some implementations, the first connector 302 may have all of O-rings 312, 314, 316 and 318.

The O-rings 312, 314, 316 and 318 may interact with corresponding channels in the electric power module 106, as described in relation to FIGS. 6 and 7. Alternatively, the O-rings may be provided in the connector depicted in FIGS. 6 and 7. This interaction provides a sealed connection for the power pins 308 and data pins 310 of the first connector 302. In this way, the interface module 300 can operate underwater without the risk of a short circuit between the pins 308, 310. For example, if only the O-ring 318 is present, a seal is provided around the first connector 302 such that water does not enter the first connector 302 and short the connection to the electric power module 106. In this way, the connection can operate underwater. Furthermore, if the O-ring 316 is present, a seal is provided around the power pins 308, preventing a short circuit between the power pins 308 and the data pins 310. In a particularly advantageous implementation, where the O-rings 312, 314 are present, the power pins 308 and data pins 310 are each individually isolated. As such, there is no path for electrons to move between any pair of pins and the risk of a short circuit is removed. This means that the interface module 300 can be disconnected from the electric power module 106 underwater, and a new electric power module 106 can be attached. As long as the electric power module 106 is not activated before the connection is complete, it can be safely connected underwater as the individual pins 308, 310 are all isolated from each other. Therefore, even if one or more of the pins 308, 310 is in contact with water within the seal when the power is activated, there is no path for electrons to move between the pins and therefore no risk of a short circuit. This provides a more flexible operation of a watercraft, as batteries can be changed while the craft is at least partially submerged. The user can therefore take spare batteries on a journey and replace them on the fly, as necessary, without having to find dry land or wait for the various components to dry out.

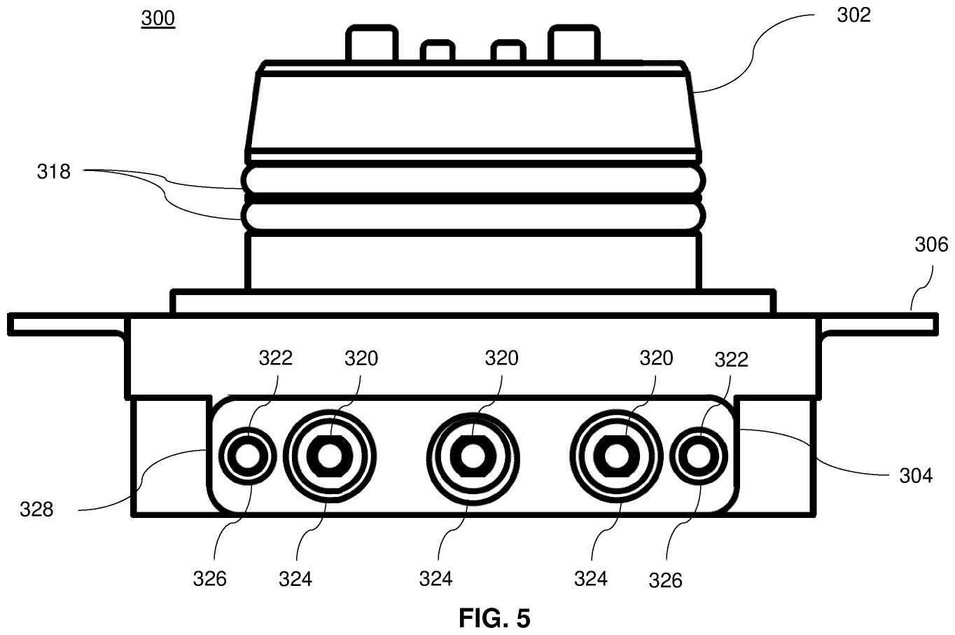

FIG. 5 shows a front view of the second connector 304. The second connector 304 is also provided with a number of sealing means in order to provide a seal around electrically active components of the second connector 304. In the example of FIG. 5, each of the power pins 320 may have one or more respective O-rings 324 in order to provide a seal around each power pin 320 when the second connector 304 is connected. Each of the data pins 322 may have one or more respective O-rings 326 in order to provide a seal around each data pin when the second connector 304 is connected. The second connector 304 may also have one or more O-rings 328 to provide a seal around the second connector 304 when the second connector 304 is connected. The second connector 304 may have any combination of O-rings 324, 326 and 328 that seal the pins 320, 322 from the outside. For example, the second connector 304 may have only O-rings 324 and 326, or only O-ring 328. In some implementations, the second connector 304 may have all of O-rings 324, 326 and 328.

The O-rings 324, 326 and 328 may interact with corresponding channels in the motor unit 110. As discussed above in relation to the first connector 302, this interaction provides a sealed connection for the power pins 320 and data pins 322 of the second connector 304 such that the interface module 300 can operate underwater without the risk of a short circuit between the pins. When the O-rings 324, 326 are present, the interface module 300 can be disconnected from the motor unit 110 underwater, and new modules can be connected. This provides a much more flexible watercraft, as modules can be changed while the craft is at least partially submerged.

Whilst FIGS. 4 and 5 show sealing means in the form of O-rings, it will be appreciated that other types of sealing means may be provided, for example radial seals, sealing gaskets, and moulded rubber seals. In examples where a releasable connection is not required, a permanent seal could be provided, for example using a silicone-based sealant.

Returning to FIG. 3, the housing 306 may be formed of a suitable heat transferring material, such as aluminium, in order to enable the passive cooling discussed above. In some implementations, the housing 306 comprises attachment means 328 for attaching the interface module 300 to a hull module 102. The attachment means 328 may be part of the hull connection 118 of FIG. 1.

The housing 306 may also include components for sensing correct attachment and operation of the interface module 300. In some implementations, the housing 306 may include components of a proximity sensing system. For example, one or magnets may be present in the housing 304, and one or more magnetic field sensors may be present in the electric power module 106 and/or the motor unit 110, for example one or more Hall-effect sensors. The magnetic field sensors sense the magnetic field produced by the magnets and can thus provide an indication of the proximity of the magnets to the magnetic field sensors. A stronger magnetic field indicates a closer proximity. As such, the proximity of the interface module 300 to the electric power module 106 and/or the motor unit 110 can be detected. Furthermore, particular pairs of magnets and magnetic field sensors can be identified and positioned such that the orientation of the interface module 300 relative to the electric power module 106 and/or the motor unit 110 can be determined. This can be used to determine whether the connections between the various modules have been made correctly. In some implementations, one or more magnetic field sensors may also be present in the hull module 102. It will be appreciated that the magnetic field sensors could be implemented in the interface module 300, with magnets in the other modules. Equally, different combinations of magnets and magnetic field sensors could be used in the different modules to enable the proximity and connection sensing disclosed above.

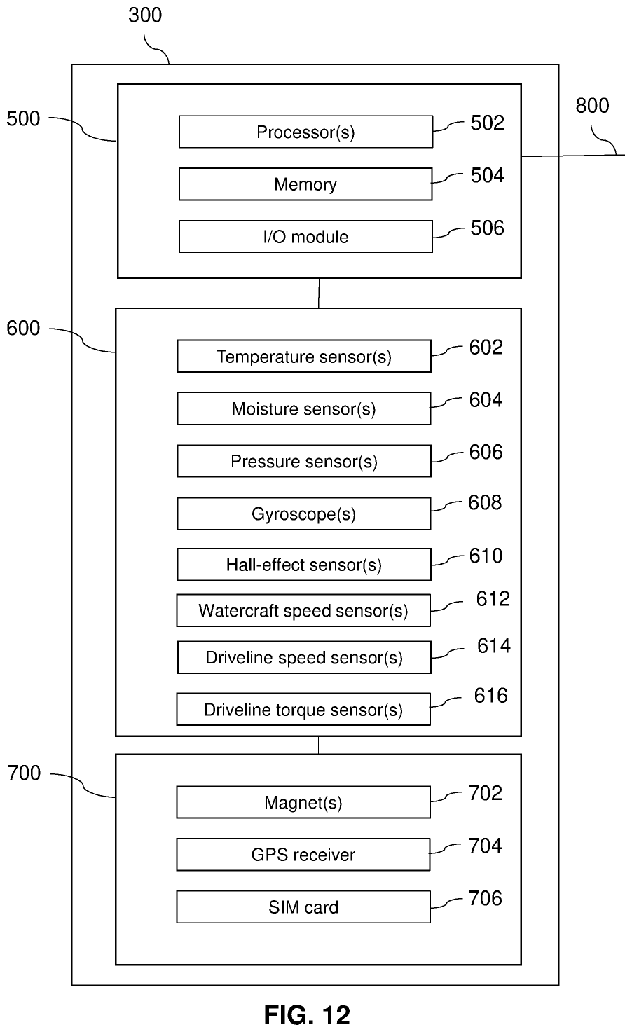

The housing 306 may also include one or more sensors for detecting parameters relevant to the operation of the interface module 300. For example, the housing may include a pressure sensor, configured to provide a pressure measurement indicative of the depth of the watercraft 100. The housing 306 may include a temperature sensor configured to detect the temperature around the watercraft 100. The housing 306 may include a moisture sensor configured to detect the presence of water in the interface module 300, in particular in the connectors 302, 304. The housing 304 may include a gyroscope configured to detect the orientation of the watercraft 100. The operation of these sensors will be explained in further detail in relation to FIG. 12.

FIG. 6 shows a battery module 400. The battery module 400 may be a sub-module of the electric power module 106. The battery module 400 comprises a connector 402 (for example, the connector 126 shown in FIG. 1) for connection to a driveline module 104. The connector 402 may be configured to connect to the first connector 302 of the interface module 300. The battery module 400 also comprises a housing 404 comprising a power source, as will be discussed below.

The connector 402 comprises a first set of electrically conductive female connectors 406 for transmitting power to the driveline module 104. In some implementations, the electrically conductive female connectors 406 are configured to receive the first set of pins 308 of the first connector 302 of the interface module 300. As such, there may be a corresponding number of power pins 308 and female connectors 406. The battery module 400 may also comprise a second set of electrically conductive female connectors 408 for receiving data from and transmitting data to the driveline module 104. In some implementations, the electrically conductive female connectors 408 are configured to receive the second set of pins 310 of the first connector 302 of the interface module 300. As such, there may be a corresponding number of data pins 310 and female connectors 406. When the interface module 300 and the battery module 400 connected, power is transferred through the power pins 308 and the female connectors 406, and data is transferred through the data pins 310 and the female connectors 408. The data connections may be Controller Area Network (CAN) connections and data may be transmitted over a CAN.

The connection between the male connectors (pins) of the interface module 300 and the female connectors of the battery module 400 may be a blind mate connection. The blind mate connection may have a sliding or snapping action that enables connection by hand, without the use of additional tools. As such, the battery module 400 can be connected to the interface module 300 by pushing the battery module 400 onto the interface module 300. The blind mate connection may have self-aligning features that allow a small misalignment when mating.

FIG. 7 shows a plan view of the connector 402. The second set of female connectors 408 is not numbered in FIG. 7 to enable the figure to be read clearly. The connector 402 is provided with a number of sealing means in order to provide a seal around electrically active components of the connector 402. In the example of FIG. 7, The connector 402 comprises one or more channels or areas that are configured to receive the O-rings of the first connector 302 in order to provide a sealed connection. For example, each of the first set of female connectors 406 may have one or more respective channels 410 in order to receive a respective O-ring 312 of a power pin 308 and provide a seal around each power pin 308 when the interface module 300 is connected to the battery module 400. Each of the second set of female connectors 408 may have one or more respective channels 412 in order to receive a respective O-ring 314 of a data pin 310 and provide a seal around each data pin 310 when the interface module 300 is connected to the battery module 400. The connector 402 may also have a channel 414 that encircles the second set of female connectors 408 in order to receive a respective O-ring 316 to provide a seal around the second set of pins 310 when the interface module 300 is connected to the battery module 400. The connector 402 may also have one or more channels 416 in order to receive a respective O-ring 318 to provide a seal around the first connector 302 and connector 402 when the interface module 300 is connected to the battery module 400. The connector 402 may have any combination of channels 410, 412, 414, 416 corresponding to the O-rings 312, 314, 316 and 318 in order to provide a sealed connection where required.

As discussed above in relation to the first connector 302 and the second connector 304, the interaction between the various O-rings and channels provides a sealed connection for the power connections and data connections, such that the interface module 300 and battery module 400 can operate underwater without the risk of a short circuit between the connections. This means that the battery module 400 can be disconnected from the interface module 300 underwater, and a new battery module 400 can be attached. As long as the battery module 400 is not activated before the connection is complete, it can be safely connected underwater as the individual connections are all isolated from each other. Therefore, even if one or more of the pins is in contact with water within the seal when the power is activated, there is no path for electrons to move between the pins and therefore no risk of a short circuit. This provides more flexible operation of a watercraft, as batteries can be changed while the craft is at least partially submerged. The user can therefore take spare battery modules 400 on a journey and replace them on the fly, as necessary, without having to find dry land or wait for the various components to dry out.

Returning to FIG. 6, the housing 404 includes one or more electrochemical cells that store energy and provide electrical power to a connected component. The electrochemical cells therefore form a battery. Any suitable type of battery could be implemented, such as Lithium ion batteries, solid state batteries or any suitable type of battery developed in the future. The electrochemical cells may be rechargeable, such that the energy levels can be replenished and the battery module 400 can be used multiple times. As such, the connector 402 may also enable connection to an associated charger. The electrochemical cells may be of any suitable weight and dimensions dependent on the requirements of the implementation of the battery module 400. For example, different watercraft may require lighter implementations than others. The housing 400 shown in FIG. 6 has a cuboidal form, although it will be appreciated that the housing 404 may have any suitable shape.

The housing 404 may be constructed of any suitable material, such as aluminium, stainless steel, carbon fibre, glass fibre, plastic, etc. The housing 404 may be waterproof to prevent water entering into the inside of the battery module 400. However, if water leaks through the housing 404, there may be a risk of a thermal runaway event in the battery module 400. Therefore, the electrochemical cells inside the housing 404 may be separated from each other using a material configured to reduce the risk of a thermal runaway event, for example fire and heat proof plastics, aluminium, stainless steel, thermal/fire protective foam or other materials that are fire or heat resistant. Separation of the cells using a suitable material enables exposed power and data connections inside of the battery module 400 to be isolated so that the chance of short-circuits inside the battery is reduced. A heat-conducting material may be disposed between the electrochemical cells and the housing 404. This material allows heat transfer between the cells and the housing 404, which enable cooling by surrounding water as discussed above.

The housing 404 may also include other components that enable the operation of the battery module 400. In some implementations, the housing 404 may include components of a proximity sensing system, such as discussed above in relation to the interface module 300. For example, one or magnets and/or magnetic field sensors may be present within the housing 404. As such, the proximity and/or orientation of the battery module 400 relative to the interface module 300 can be detected. This can be used to determine whether the connections between the modules have been made correctly. It will be appreciated that different combinations of magnets and magnetic field sensors could be used in the different modules to enable the proximity and connection sensing disclosed above.

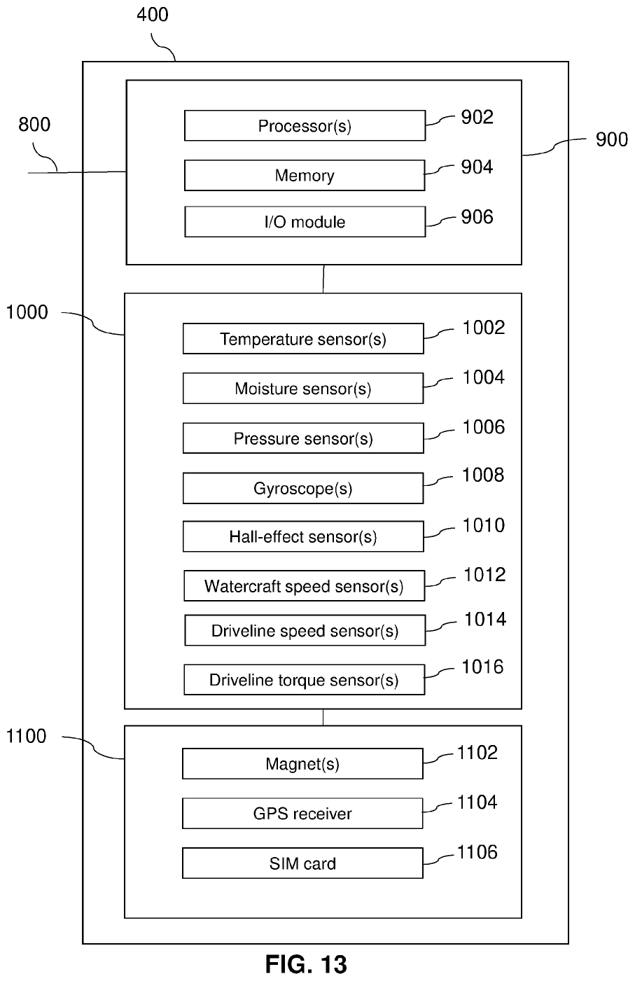

The housing 404 may also include one or more sensors for detecting parameters relevant to the operation of the battery module 400. For example, the housing may include a pressure sensor, configured to provide a pressure measurement indicative of the depth of the watercraft 100. The housing may include a temperature sensor configured to detect the temperature around the watercraft 100. The housing 404 may include a moisture sensor configured to detect the presence of water in the interface module 300, in particular in the connector 402. The housing 404 may include a gyroscope configured to detect the orientation of the watercraft 100. The operation of these sensors will be explained in further detail in relation to FIG. 13.

The housing 404 may also include a hinge switch (not shown). The hinge switch is operable to activate the battery module 400. That is to say, when the hinge switch is engaged, the battery module 400 provides electrical power to the driveline module 104. The hinge switch may comprise a locking mechanism that is configured to enable engagement of the hinge switch only when the battery is properly connected.

In some implementations, a proximity sensing system may be used on the locking mechanism of the hinge switch to detect whether the locking mechanism is properly closed before the battery module can be activated. Other types of switch could be used in the driveline system which can be monitored to determine if they are in an on or off position.

In the examples of FIGS. 3 to 7, the interface module 300 is shown to have male connectors, and therefore act as a plug, while the battery module 400 is shown to have female connectors, and therefore act as a socket. However, it will be appreciated that any suitable combination of male and female connectors could be used as long as an electrical connection is formed when the interface module 300 is connected to the battery module 400. For example, the interface module 300 may have female connectors, while the battery module 400 may have male connectors. In the examples of FIGS. 3 to 7, O-rings are shown to be disposed around the male connectors, with corresponding channels around the female connectors. However, it will be appreciated that any suitable positioning of O-rings and channels could be used as long as the required seal is formed when the interface module 300 is connected to the battery module 400. For example, the O-rings may be disposed around the female connectors, with corresponding channels around the male connectors. In some implementations, two O-rings could be used in a single seal.

Whilst the examples of FIGS. 3 to 7 show that one battery module 400 is connected to one interface module 300, in some implementations more than one battery module 400 can be connected to a single interface module 300. This enables a larger power supply to be provided to an interface module 300 (for example a power supply having more Ampere hours or a higher voltage). To enable this, the interface module 300 may comprise further connectors 302 to allow multiple battery modules 400 to be connected. In some implementations, the battery modules 400 themselves may have connectors to enable them to be connected together. In this way, a first battery module 400 may be connected to an interface module 300, and further battery modules 400 may be connected to the first battery module 400.

Whilst the interface module 300 and battery module 400 have been described in relation to watercraft, it will be appreciated that the advantages of such a connection can be useful in other implementations where a modular approach to power is desired. In relation to vehicles, the connections could be used in an aeroplane, skateboard, car, scooter, snowmobile and the like. Whilst the connector depicted in FIGS. 3 to 5 have been described in relation to the driveline module and the connector depicted in FIGS. 6 to 7 have been described in relation to the electric power module, it will be appreciated that the second module may be coupled to the driveline module and the first module may be coupled to the electric power module.

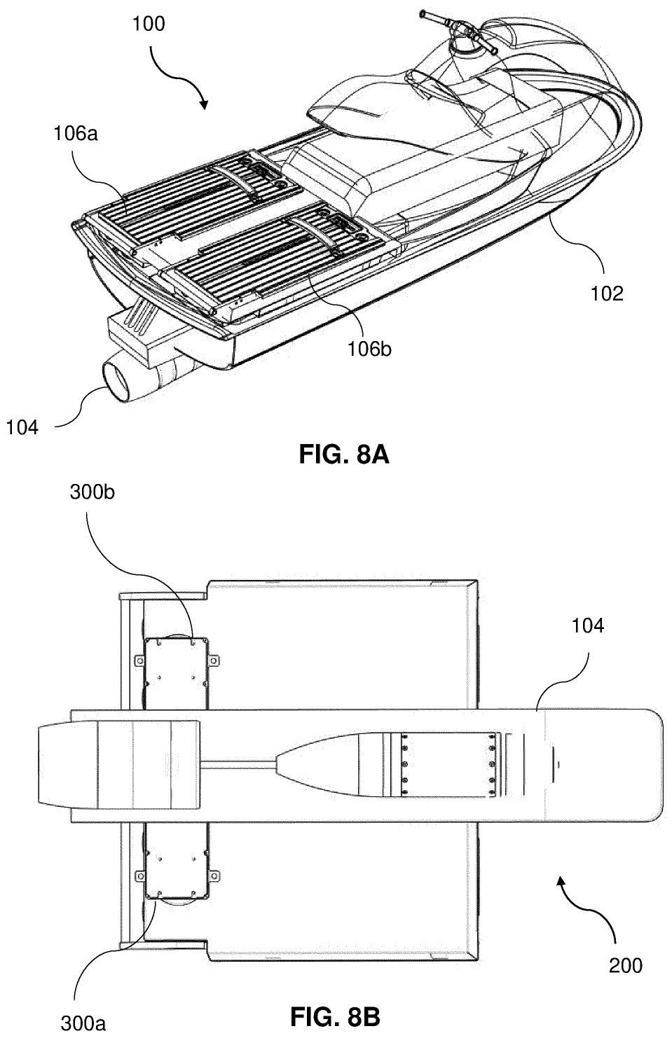

FIGS. 8 to 10 show different watercraft 100 that can be formed using the modular approach discussed above. These are shown as examples only, and are not intended to be limiting.

FIG. 8A illustrates a watercraft 100 in the form of a jet ski. FIG. 8B illustrates a driveline system 200 of the watercraft 100 shown in FIG. 8A from underneath. The jet ski 100 has a hull module 102 in the shape of a jet ski body. The jet ski 100 is driven by a single driveline module 104 disposed underneath the hull module 102 and configured to provide propulsion of the jet ski 100 in a forward direction. The driveline module 104 in this example is connected to two electric power modules 106a, 106b. The electric power modules 106a, 106b are connected to respective interface modules 300a, 300b of the driveline module 200.

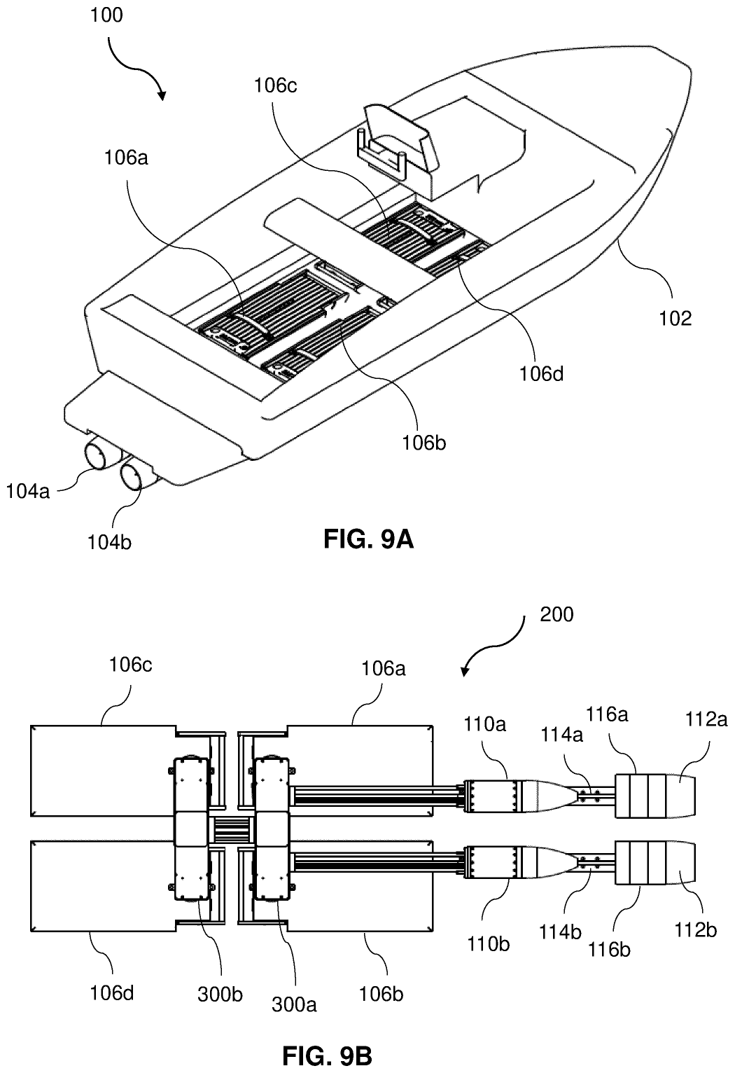

FIG. 9A illustrates a watercraft 100 in the form of a boat. FIG. 9B illustrates a driveline system 200 of the watercraft 100 shown in FIG. 9A from underneath the driveline system 200. The boat 100 has a hull module 102 in the shape of a boat body. The boat 100 is driven by two driveline modules 104a, 104b disposed underneath the hull module 102 and configured to provide propulsion of the boat 100 in a forward direction. The driveline modules 104a, 104b each comprise a respective motor unit 110a, 110b in driving connection with a respective propelling member 112a, 112b via a respective drive shaft 114a, 114b. Each propelling member 112a, 112b is surrounded by a respective waterproof casing or pod 116a, 116b.

The driveline modules 104a, 104b in this example are connected to a first interface module 300a. The first interface module 300a is connected to two electric power modules 106a, 106b. The first interface module 300a is further connected to a second interface module 300b. The second interface module 300b is connected to two further electric power modules 106c, 106d. As such, the two driveline modules 104a, 104b are powered by four electric power modules 106a, 106b, 106c, 106d.

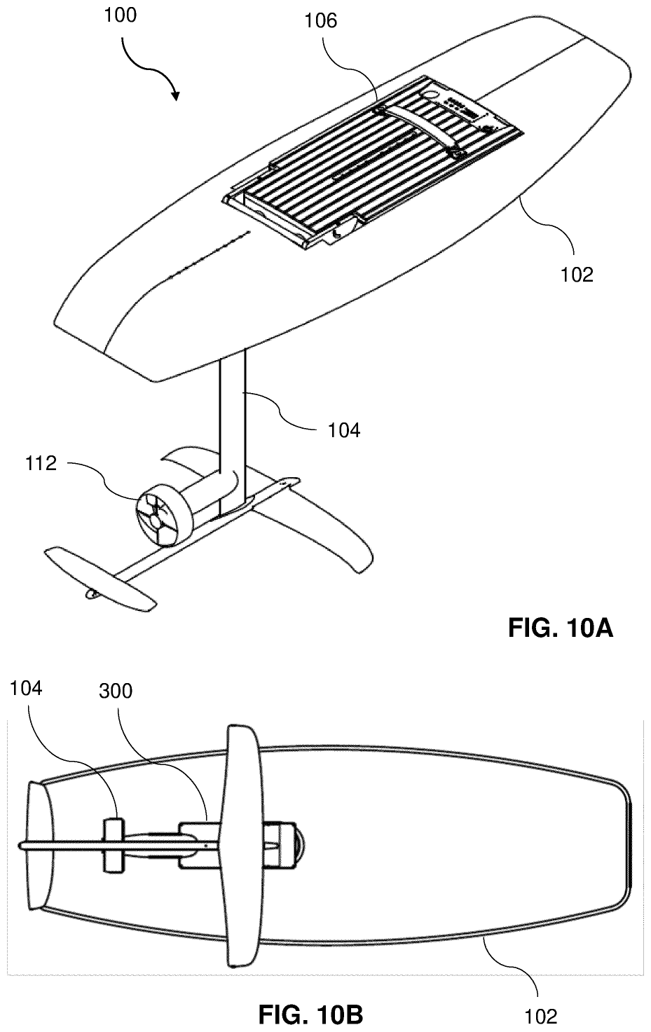

FIG. 10A illustrates a watercraft 100 in the form of a hydrofoiling watercraft. FIG. 10B illustrates the hydrofoiling watercraft 100 shown in FIG. 10A from underneath. The hydrofoiling watercraft 100 has a hull module 102 in the shape of a hydrofoil. The hydrofoiling watercraft 100 is driven by a single driveline module 104 disposed underneath the hull module 102 and configured to provide propulsion of the hydrofoiling watercraft 100. The driveline module comprises a propeller 112 and a number of struts and wings. The driveline module 104 in this example is connected to a single electric power module 106. The electric power module 106 is connected to a single interface module 300 of the driveline module 104.

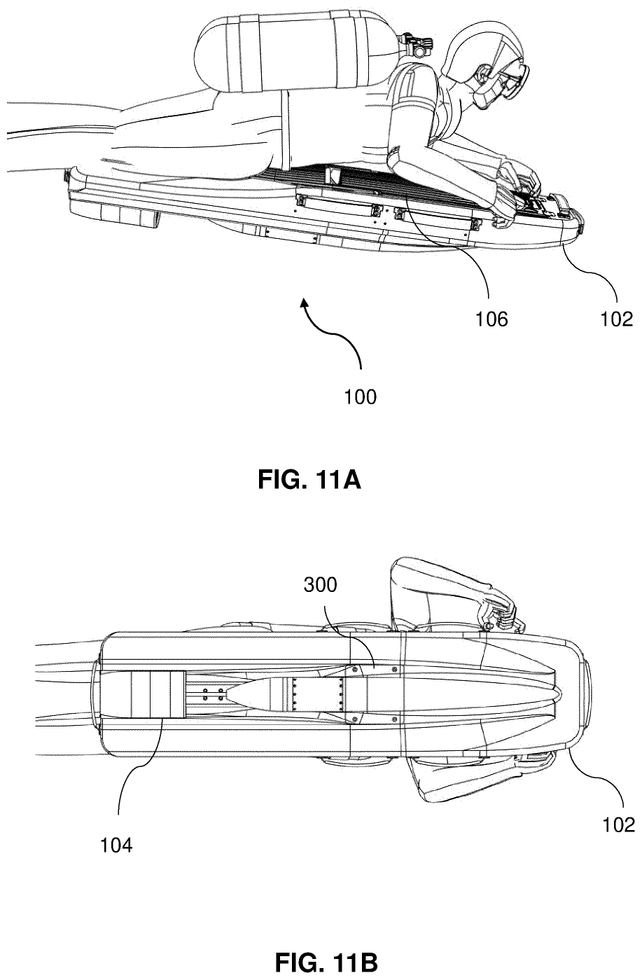

FIG. 11A illustrates a watercraft 100 in the form of a personal underwater craft. FIG. 11B illustrates the personal underwater craft 100 shown in FIG. 11A from underneath. The personal underwater craft 100 has a hull module 102 in the shape of a board. The personal underwater craft 100 is driven by a single driveline module 104 disposed underneath the hull module 102 and configured to provide propulsion of the personal underwater craft 100. The driveline module 104 in this example is connected to a single electric power module 106. The electric power module 106 is connected to a single interface module 300 of the driveline module 104.

When the hull module 102, driveline module 104, and electric power module 106 are assembled, the watercraft 100 may be ready for operation. However, it may be desirable that safe and efficient operation of the watercraft 100 is ensured both before and during operation by the user. As such, the modules may comprise a control system that enables safe and efficient operation of the watercraft 100. The control system may be distributed across the watercraft 100, for example in the driveline module 104 and/or the electric power module 106.

FIG. 12 shows a schematic view of control components of an interface module 300. The interface module 300 comprises a control unit 500, sensors 600 and operational components 700. The control unit 500 may be communicatively coupled to the sensors 600 and operational components 700. The interface module 300 is communicatively coupled to other modules by a connection 800. Data communication between the various components may be made by CAN as discussed above. Data communication may also be made using other wired or wireless data connections known in the art.

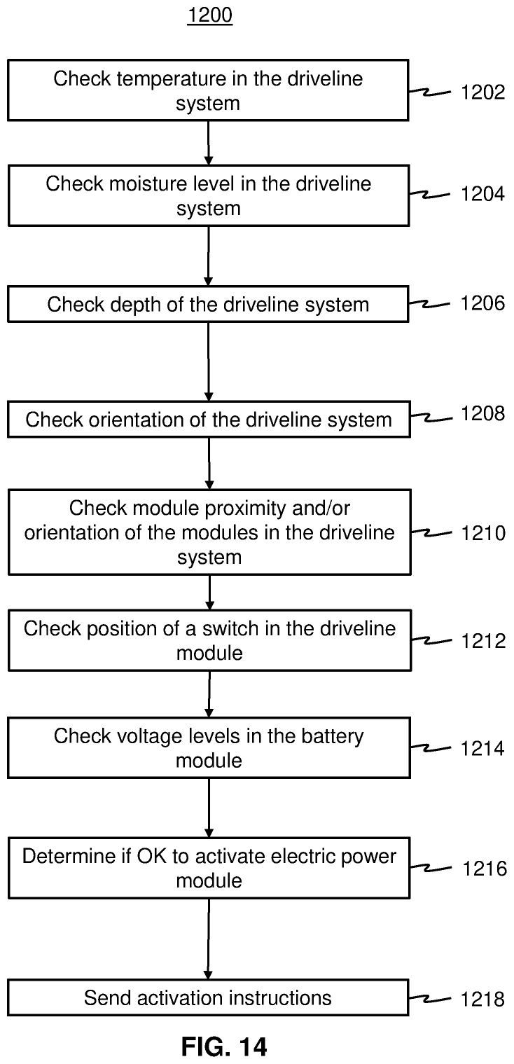

The control unit 500 of the interface module 300 comprises one or more processors 502, a memory 504, and an input/output (I/O) module 506. The memory 504 may store a software program in the form of code that is executable by the processor 502. Input information may be received by the I/O module 506. The input information may include information from the sensors 600 and/or operational components 700 relating to the condition and/or operation of the interface module 300 and/or the watercraft 100 as a whole. The input information may also include information input by a user, for example an indication of a type of hull module 102 to which the interface module 300 is connected. Based on the input information, the control unit 500 can control operation of the watercraft 100. Specifically, the software program stored in the memory 504 is operable to use the input information to determine operating instructions for the driveline module 104. For example, operating instructions may be provided to an ESC, via the connection 800, which controls the speed of the motor unit 110. The ESC may be disposed in the motor unit 110, the interface module 300, the battery module 400 or other suitable location in the watercraft 100. Operation of the software program will be discussed in more detail in relation to FIGS. 14 and 15. The memory 504 may further store information received from the sensors 600 and/or operational components 700, or from other components of the system to which the interface module 300 is connected, for later use/reference.

The sensors 600 comprise means for detecting information relating to the condition and/or operation of the interface module 300 and/or the watercraft 100 as a whole. For example, the sensors 600 may comprise one or more temperature sensors 602. The temperature sensors 602 may detect the temperature in the interface module 300, for example in the first connector 302 or the second connector 304. The sensors 600 may also comprise one or more moisture sensors 604. The moisture sensors 604 may detect moisture in the interface module 300, for example in the first connector 302 or the second connector 304. The sensors 600 may also comprise one or more pressure sensors 606. The pressure sensors 606 may detect pressure in the interface module 300, which may be indicative of the depth of the interface module 300 and, as such, the watercraft 100. The sensors 600 may also comprise one or more gyroscopes 608. The gyroscopes 608 may detect the orientation of the interface module 300, which may be indicative of the orientation of the watercraft 100. The sensors 600 may also comprise one or more magnetic field sensors 610, for example one or more Hall-effect sensors. The magnetic field sensors 610 may act together with corresponding magnets in another module to detect the proximity and/or orientation of those modules with respect to the interface module 300.

The sensors 600 may comprise one or more watercraft speed sensors 612. The watercraft speed sensors 602 may be configured to determine the speed of the watercraft, i.e. the travelling speed of the watercraft. The one or more watercraft speed sensors may comprise a GPS receiver and/or an accelerometer configured to detect the travelling speed of the watercraft. The watercraft speed sensors may further be configured to detect the acceleration of the watercraft.

The sensors 600 may comprise one or more driveline speed sensors 614. The driveline speed sensors may be configured to determine the speed at which the driveline module operates. The driveline speed sensors may be configured to determine the speed at which the motor unit of the driveline module operates. The driveline speed sensors may thus comprise a motor speed sensor configured to detect the motor speed of the motor unit of the driveline module. The motor speed sensor may be of any conventional type of motor speed sensor. The driveline speed sensors may be RPM (revolutions per minute) sensors. The RPM sensors may be configured to sense the RPM, i.e. the motor speed, of the motor unit based on the phase, current or voltage of the motor unit. The driveline speed sensors 614 may be disposed in the driveline module.

The sensors 600 may comprise one or more driveline torque sensors 616. The driveline torque sensors may be configured to determine the torque provided by the driveline module. The driveline torque sensors may be configured to determine the torque provided by the motor unit of the driveline module. The driveline torque sensors may thus comprise a motor torque sensor configured to detect the torque provided by the motor unit. The motor torque sensor may be of any conventional type of motor torque sensor. The driveline torque sensors may be configured to detect the torque based on the current, resistance or voltage over the motor unit of the driveline module. The driveline torque sensors may be disposed in the driveline module.

The operational components 700 comprise other components used in the operation of the interface module 300 and/or the watercraft 100 as a whole. For example, the operational components 700 may comprise one or more magnets 702, which act together with corresponding magnetic field sensors in another module to detect the proximity and/or orientation of those modules with respect to the interface module 300. The operational components 700 may also comprise a GPS receiver 704. The GPS receiver 704 may be configured to output a location of the interface module 300 and/or the watercraft 100 as a whole.

The location may be monitored and used to determine a speed of the watercraft 100. The operational components 700 may also comprise a subscriber identification module (SIM) card 706. The SIM card 706 can be used to communicate over the internet and therefore provide data about the interface module 300 and/or the watercraft 100 as a whole to a remote service, for example a cloud-based service.

FIG. 13 shows a schematic view of control components of the battery module 400. The battery module 400 comprises a control unit 900, sensors 1000 and operational components 1100. The control unit 900 may be communicatively coupled to the sensors 1000 and operational components 1100. The battery module 400 is communicatively coupled to other modules by a connection 800. The communication between the various components may be made by CAN as discussed above. The communication may also be made using other wired or wireless data connections known in the art.

The control unit 900 of the battery module 400 comprises one or more processors 902, a memory 904, and an I/O module 906. The memory 904 may store a software program in the form of code that is executable by the processor 902. Input information may be received by the I/O module 906. The input information may include information from the sensors 1000 and/or operational components 1100 relating to the condition and/or operation of the battery module 400 and/or the watercraft 100 as a whole. The input information may also include information input by a user, for example an indication of a type of hull module 102 to which the battery module 400 is connected. Based on the input information, the control unit 900 can control operation of the watercraft 100. The software program stored in the memory 904 is operable to use the input information to determine operating instructions for the driveline module 104. For example, operating instructions may be provided to the ESC, via the connection 800, which controls the speed of the motor unit 110. The ESC may be disposed in the motor unit 110, the interface module 300, the battery module 400 or other suitable location in the watercraft 100. Operation of the software program will be discussed in more detail in relation to FIGS. 14 and 15. The memory 904 may further store information received from the sensors 1000 and/or operational components 1100, or from other components of the system to which the battery module 400 is connected, for later use/reference.

The sensors 1000 comprise means for detecting information relation to the condition and/or operation of the battery module 400 and/or the watercraft 100 as a whole. For example, the sensors 1000 may comprise one or more temperature sensors 1002. The temperature sensors 1002 may detect the temperature in the battery module 400, for example in the connector 402. The sensors 1000 may also comprise one or more moisture sensors 1004. The moisture sensors 1004 may detect moisture in the battery module 400, for example in the connector 402. The sensors 1000 may also comprise one or more pressure sensors 1006. The pressure sensors 1006 may detect pressure in the battery module 400, which may be indicative of the depth of the battery module 400 and, as such, the watercraft 100. The sensors 1000 may also comprise one or more gyroscopes 1008. The gyroscopes 1008 may detect the orientation of the battery module 400, which may be indicative of the orientation of the watercraft 100. The sensors 1000 may also comprise one or more magnetic field sensors 1010, for example one or more Hall-effect sensors. The magnetic field sensors 1010 may act together with corresponding magnets in another module to detect the proximity and/or orientation of those modules with respect to the battery module 400.

The sensors 1000 may comprise one or more watercraft speed sensors 1012. The watercraft speed sensors 1012 may be configured to determine the speed of the watercraft, i.e. the travelling speed of the watercraft. The one or more watercraft speed sensors may comprise a GPS receiver and/or an accelerometer configured to detect the travelling speed of the watercraft. The watercraft speed sensors may further be configured to detect the acceleration of the watercraft.

The sensors 1000 may comprise one or more driveline speed sensors 1014. The driveline speed sensors may be configured to determine the speed at which the driveline module operates. The driveline speed sensors may be configured to determine the speed at which the motor unit of the driveline module operates. The driveline speed sensors may thus comprise a motor speed sensor configured to detect the motor speed of the motor unit of the driveline module. The motor speed sensor may be of any conventional type of motor speed sensor. The driveline speed sensors may be RPM sensors. The RPM sensors may be configured to sense the RPM of the motor unit, i.e. motor speed of the motor unit, based on the phase, current or voltage of the motor unit. The driveline speed sensors 1014 may be disposed in the driveline module.

The sensors 1000 may comprise one or more driveline torque sensors 1016. The driveline torque sensors may be configured to determine the torque provided by the driveline module. The driveline torque sensors may be configured to determine the torque provided by the motor unit of the driveline module. The driveline torque sensors may thus comprise a motor torque sensor configured to detect the torque provided by the motor unit. The motor torque sensor may be of any conventional type of motor torque sensor. The driveline torque sensors may be configured to detect the torque based on the current, resistance or voltage over the motor unit of the driveline module. The driveline torque sensors may be disposed in the driveline module.

The operational components 1100 comprise other components used in the operation of the battery module 400 and/or the watercraft 100 as a whole. For example, the operational components 1100 may comprise one or more magnets 1102, which act together with corresponding magnetic field sensors in another module to detect the proximity and/or orientation of those modules with respect to the battery module 400. The operational components 1100 may also comprise a GPS receiver 1104. The GPS receiver 1104 may be configured to output a location of the battery module 400 and/or the watercraft 100 as a whole. The location may be monitored and used to determine a speed of the watercraft 100. The operational components 1100 may also comprise a SIM card 1106. The SIM card 1106 can be used to communicate over the internet and therefore provide data about the battery module 400 and/or the watercraft 100 as a whole to a remote service, for example a cloud-based service.

The interface module 300 and the battery module 400 may be communicatively coupled by the connection 800. This may be implemented by the first connector 302 of the interface module 300 and the connector 402 of the battery module 400, as discussed above. In this way, data can be transmitted between the interface module 300 and the battery module 400, and operation of the entire driveline system 200 may be monitored and controlled by either the interface module 300 or the battery module 400. In particular, the control unit 500 of the interface module 300 or the control unit 900 of the battery module 400 may receive information from the sensors 600, 1000 and/or operational components 700, 1100 relating to the condition and/or operation of the interface module 300, the battery module 400 and/or the watercraft 100 as a whole. This information can be used by the software program to provide operating instructions to the motor unit 110, for example via an ESC.

In this way, only a single control unit having the software program may need to be present in the driveline system 200. It will be appreciated that not all sensors 600, 1000 and operational components 700, 1100 need to be present in the control system. Some sensors 600, 1000 and operational components 700, 1100 can be present in the interface module 300 and others in the battery module 400, or vice versa. Some sensors 600, 1000 and operational components 700, 1100 may be absent entirely. For example, only a single pressure sensor 606, 1006 may be required, as the depth of either the interface module 300 or the battery module 400 will be indicative of the depth of the watercraft 100. Similarly, only a single gyroscope 608, 1008 may be required, as the orientation of either the interface module 300 or the battery module 400 will be indicative of the orientation of the watercraft 100. As discussed above, in some implementations, the interface module 300 may comprise magnets 702 while the battery module 400 comprises corresponding magnetic field sensors 1010. In other implementations, the battery module 400 may comprise magnets 1102 while the interface module 300 comprises corresponding magnetic field sensors 610. In some implementations, the interface module 300 and the battery module 400 may both have a combination of magnets and magnetic field sensors that operate with corresponding components on the other module to provide the proximity sensing functionality.

FIG. 14 is a flow chart illustrating a method 1200 that may be implemented by the control unit 500 of the interface module 300 and/or the control unit 900 of the battery module 400. The method may be implemented using the software program discussed above. The method 1200 is used to control activation of the driveline system 200 and/or the watercraft 100 as a whole.

At step 1202, the temperature level in the driveline system 200 is checked. This can be achieved using the temperature sensors 602, 1002 in the interface module 300 and the battery module 400. For example, the temperature may be sensed in at least one of the first connector 302 of the interface module 300, the second connector 304 of the interface module 300, the housing 306 of the interface module, the connector 402 of the battery module 400 and/or the housing 404 of the battery module 400. The sensed temperature(s) may be compared to one or more temperature thresholds related to safe operation of the driveline system 200. For example, a lower threshold temperature and an upper threshold temperature may define a temperature range for safe operation of the driveline system 200. If the measured temperature anywhere in the driveline system 200 is below the lower threshold temperature or above the upper threshold temperature, it may be determined that it is unsafe to activate the driveline system 200.

At step 1204, the moisture level in the driveline system 200 is checked. This can be achieved using the moisture sensors 604, 1004 in the interface module 300 and the battery module 400. For example, the moisture may be sensed in at least one of the first connector 302 of the interface module 300, the second connector 304 of the interface module 300, the housing 306 of the interface module, the connector 402 of the battery module 400 and/or the housing 404 of the battery module 400. The sensed moisture level(s) may be compared to one or more moisture thresholds related to safe operation of the driveline system 200. If the measured moisture anywhere in the driveline system 200 is above the threshold, it may be determined that it is unsafe to activate the driveline system 200.

At step 1206, the depth of the driveline system 200 may be checked. This can be achieved using the pressure sensors 606, 1006 in the interface module 300 and the battery module 400. For example, the pressure in at least one of the interface module 300 and the battery module 400 may be sensed. The sensed pressure may be indicative of the depth of the watercraft 100. The sensed pressure/depth may be compared to one or more thresholds related to safe operation of the driveline system 200. If it is determined that the watercraft 100 is below a threshold depth (i.e., the measured depth is above the threshold), it may be determined that it is unsafe to activate the driveline system 200 as the watercraft 100 is too deep in the water.

At step 1208, the orientation of the driveline system 200 is checked. This can be achieved using the gyroscopes 608, 1008 in the interface module 300 and the battery module 400. For example, the orientation of at least one of the interface module 300 and the battery module 400 may be sensed. The sensed orientation may be indicative of the orientation of the watercraft 100. In some implementations, if it is determined that the watercraft 100 is upside down, for example indicating that the watercraft 100 has capsized, it may be determined that it is unsafe to activate the driveline system 200. In some implementations, the watercraft 100 may be operable upside down, and therefore checking the orientation is not required.

At step 1210, the proximity and/or orientation of the modules in the driveline system 200 with respect to each other is checked. In this way, it can be determined if the modules are correctly connected to each other. For example, one or more magnets 702, 1102 and one or more corresponding magnetic field sensors 610, 1010 may be present in the interface module 300 and the battery module 400. As discussed above, the magnetic field sensors 610, 1010 can measure the magnetic fields from the magnets 702, 1102. The strength of the magnetic field may be compared to one or more thresholds which indicates that the modules are correctly coupled. If the measured magnetic field strength anywhere in the driveline system 200 is below the threshold, it may be determined that the modules are not properly connected and that it is unsafe to activate the driveline system 200.

At step 1212, the position of a switch in the driveline system 200 may be checked. For example, a hinge switch may be present in the battery module 400. A magnet 1102 and magnetic field sensor 1010 pair may be implemented to determine if the hinge switch is in an open (off) or closed (on) position. If the hinge switch is closed, it may be determined that the driveline system 200 can be activated. If the hinge switch is open, it may be determined that the driveline system 200 cannot be activated. Other types of switch could be used in the driveline system which can be monitored to determine if they are in an on or off position.

At step 1214, the voltage of the batteries in the battery module 400 may be checked. This may be done using any suitable voltage measurement technique known in the art. The measured voltage may be compared to one or more voltage thresholds. For example, a total voltage threshold for the whole electric power system 106 may be set, such that the combination of all batteries in the electric power system 106 need to provide a certain voltage. Alternatively or additionally, individual voltage thresholds for the respective batteries in the electric power system 106 may be set, such that each battery in the electric power system 106 needs to provide a certain voltage. If it is determined that one of these thresholds is not met, it may be determined that the driveline system 200 cannot be activated.

Once the checks at steps 1202 to 1214 have been performed, it may be determined if it is OK to activate the driveline system 200 at step 1216. For example, if it is determined that the driveline system 200 is at a safe temperature, moisture level and depth, that the modules are correctly connected and the switch is engaged, and that a sufficient voltage is being supplied from the electric power system 106, the driveline system 200 may be activated. It will be appreciated that some of the checks at steps 1202 to 1214 may be omitted in certain implementations.

If it is determined at step 1216 that it is OK to activate the driveline system 200, instructions are sent at step 1218 enabling activation of the driveline system 200. The instructions are sent to activate the main power (high voltage system) from the battery module 400 to the rest of the system. Before this, only the data pins, and/or 12-volt pins (not shown) for connecting an external mechanical or electrical connector, may be activated.

If it is determined at step 1216 that it is not OK to activate the driveline system 200, instructions are sent prohibiting activation of the driveline system 200 or shutting down the driveline system 200. Additionally or alternatively, an alert may be issued indicating that at least one criteria has not been met and that the driveline system should not be activated or should be shut down. The alert may be issued on a user interface of the driveline system 200 or via a user device, for example the remote control unit 108.

The method 1200 ensures safe operation of the driveline system 200, as it is determined if any conditions are present that preclude safe activation of the system. The method 1200 may be performed at initial start-up of the driveline system 200. The method 1200 may also be performed during operation of the watercraft 100, to ensure that none of the measured parameters discussed above have changed during operation. The method 1200 may be performed periodically or on initiation by a user.

FIG. 15 is a flow chart illustrating a method 1300 that may be implemented by a control unit 500 of the interface module 300 or a control unit 900 of the battery module 400. The method may be implemented using the software program discussed above. The method 1300 is used to control the speed and/or power of the driveline system 200 and/or the watercraft 100 as a whole.

At step 1350, at least one operating condition of the watercraft is determined. The at least one operating condition may be associated with a parameter relating to the operation of the watercraft. The at least one operating condition may include at least one of the type of the hull module, the depth of the watercraft, the number of batteries in the electric power module, a level of charge remaining in the batteries, the speed at which driveline module operates, the orientation of the watercraft, the torque provided by the driveline module and the speed of the watercraft.

At step 1360, a target speed, a target acceleration and/or target power for the watercraft is determined based on the at least one determined operating condition. The target speed, target acceleration and/or target power may be a target speed, target acceleration and/or target power for the driveline module of the watercraft. The target speed, target acceleration and/or target power may be a target speed, target acceleration and/or target power for the motor unit of the driveline module. The target power may thus be considered a target effect for the motor unit.

At step 1370, a control signal is generated for the driveline module based on the target speed, target acceleration and/or target power. The control unit may be configured to control the driveline module based on said control signal. The method may comprise controlling the driveline module, i.e. controlling the operation of the driveline module, based on the control signal.

In one embodiment, the target power may be based at least on the speed of the watercraft, i.e. travelling speed of the watercraft, and the speed at which the driveline module operates. This allows for identification of the watercraft being propelled forward by a wave or starting to hydrofoil since the travelling speed of the watercraft in such a situation will not match the speed at which the driveline module operates. The control signal may in such a situation indicate a target power which is lower than the current power to reduce energy consumption. This is particularly useful in the case of the watercraft being a hydrofoil watercraft. The method may thus comprise determining a target power based on the speed of the watercraft exceeding a threshold watercraft speed associated with the speed at which the driveline module operates.

In one embodiment, the target acceleration is based at least on the speed of the watercraft, i.e. the travelling speed of the watercraft, and the speed at which the driveline module operates. This allows for identification of the watercraft being propelled forward by a wave or starting to hydrofoil since the travelling speed of the watercraft will not match the speed at which the driveline module operates. The control signal may in such a situation indicate a target acceleration which is lower than the current acceleration to reduce risk for the user falling as the watercraft beings to hydrofoil and the drag is severely reduced. This is particularly useful in the case of the watercraft being a hydrofoil watercraft. The method may thus comprise determining a target acceleration at least based on the speed of the watercraft exceeding a threshold watercraft speed associated with the speed at which the driveline module operates.

In one embodiment, the target acceleration is based at least on the torque provided by the driveline module, e.g. the motor unit of the driveline module. For example, a rapid reduction in torque provided by the driveline module may indicate that the jet or propeller of the driveline module is at least partly above water. The control signal may in such a situation indicate a target acceleration which is lower than the current acceleration to reduce risk for the user falling and/or reduce energy consumption. This is particularly useful in the case of the watercraft being a hydrofoil watercraft. The method may thus comprise determining a target acceleration at least based on the torque provided by the driveline module being lower than a torque threshold.

In one embodiment, the target speed is based at least on the orientation of the watercraft. The orientation may be in the form of tilting about a substantially horizontal axis orthogonal to the extension of the hull. The tilting may be detectable by means of the one or more gyroscopes. This allows for control of the speed of the driveline module to stabilize the watercraft if the front of the watercraft begins to tilt upwards or downwards. If the watercraft beings to hydrofoil, the target speed may be set to a lower speed compared to the current speed in order to reduce consumption and stabilize the watercraft. If the watercraft beings to dip from a hydrofoiling position, the target speed may be set to a higher speed compared to the current speed in order maintain hydrofoiling. This is thus particularly useful in the case of the watercraft being a hydrofoil watercraft. In one embodiment, where multiple driveline modules are implemented, the orientation may be in the form of tilting about a substantially horizontal axis extending along the extension of the hull. The tilting may be detectable by means of the one or more gyroscopes. During tilting about said axis, the target speed may be adapted in order to stabilize the watercraft. The method may thus comprise determining the target speed at least based on the tilting of the watercraft being lower and/or higher than an angle interval.

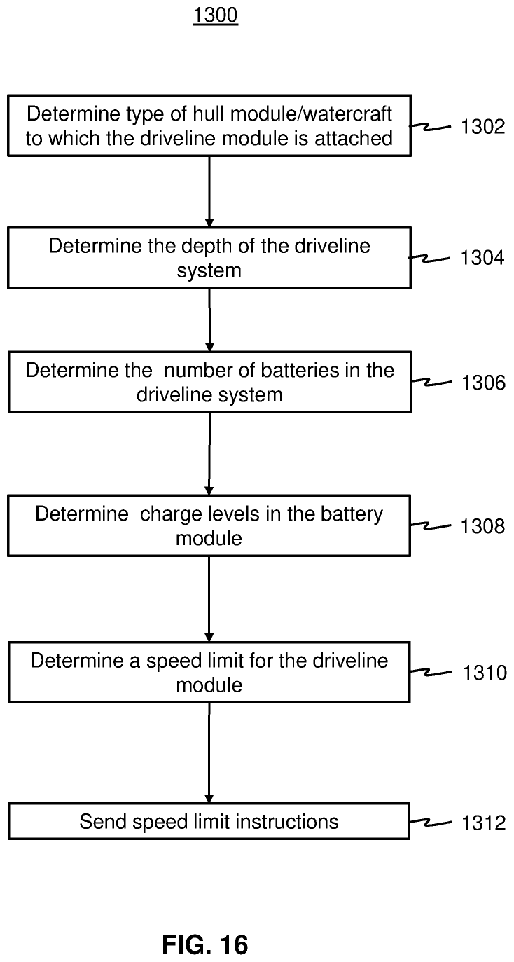

FIG. 16 is a flow chart illustrating an embodiment of the method 1300 that may be implemented by the control unit 500 of the interface module 300 or the control unit 900 of the battery module 400. The method may be implemented using the software program discussed above. The method 1300 is used to control the speed and/or power of the driveline system 200 and/or the watercraft 100 as a whole.

At step 1302, it is determined to which type of hull module 102 the driveline system 200 is attached. The hull module 102 is indicative of the type of watercraft 100 that is formed when the driveline system 200 is connected. As discussed above, the hull module 102 may comprise a hull of a hydrofoiling watercraft, hydroplane, surfboard, jet ski/water scooter, inflatable craft, overwater drone, underwater drone, submarine or boat. Each different type of craft may be capable of different safe speeds of operation. Therefore, a maximum safe speed may be set based on the type of hull module 102 the driveline system 200 is attached. The determination of the type of hull module 102 may be made by pre-programming the control unit 500 of the interface module 300 or the control unit 900 of the battery module 400 for operation with a particular type of hull module 102. Alternatively, the control units 500, 900 may interface with the hull module 102 to determine what type of hull module it is, for example by some sort of handshaking procedure. For example, a QR code indicating the type of hull module 102 may be read by a QR code reader of the remote control unit 108, or the user may input this information through a user interface of the remote control unit 108.

At step 1304, the depth of the driveline system 200 may be determined. This can be achieved using the pressure sensors 606, 1006 in the interface module 300 and the battery module 400, as discussed above. The safe maximum speed of the driveline system 200 may be related to the depth. For example, it may be allowed for the driveline system 200 to reach higher speeds towards the surface of the water compared to lower depths, where high speeds may be unnecessary and high RPM of the motor could be dangerous or cause cavitation (formation of vapour-filled cavities) around the propelling member 112. Therefore, a maximum safe speed may be set based on the determined depth of the driveline system 200.

At step 1306, the number of batteries in the driveline system 200 may be determined. Using the communicative coupling between the modules, the number of batteries in the electric power system 106 can be determined. The maximum speed of the driveline system 200 may be limited in the case that there are too few batteries connected. This ensures that the individual batteries are not overloaded. The speed limit can be determined based on a maximum power that is allowed to be drawn from each battery. For example, if a driveline system 200 is designed to draw power from four batteries but only three batteries are connected, the power that is drawn by the driveline system 200 may be reduced to 75% of the normal level, to ensure that the batteries are not overloaded.

At step 1308, the charge remaining in the batteries in the battery module 400 may be checked. This may be done using any suitable voltage measurement technique known in the art. The measured voltage may be indicative of the charge that is available in the battery. Alternatively, the batteries themselves may output a charge level. The power drawn from each battery by the driveline system 200 can be limited if the charge level in the battery is low. As in step 1306, the speed limit can be determined based on a maximum power that is allowed to be drawn from each battery.

Once the relevant parameters have been determined at steps 1302 to 1308, a speed and/or power limit for the driveline system 200 or the watercraft 100 may be determined at step 1310. Using the parameters discussed above, the speed and/or power limit may be determined based on a safe operating speed of the watercraft 100 and/or based on the available power in the electric power system 106. The speed limit may be set by setting a maximum RPM of the motor unit 110. In the example of an underwater craft, the RPM could be limited underwater and increased overwater. The RPM could be reduced or the motor could be stopped entirely if the watercraft 100 goes under a certain depth. In the example of a hydrofoiling craft, the system can adapt in such a way that a higher power is used automatically when the craft is accelerating, and once the hull module 102 reaches the surface of the water the RPM can be limited to allow the watercraft 100 to cruise at a suitable speed. It will be appreciated that some of the parameters determined in steps 1302 to 1308 may be omitted in certain implementations.

Once the speed and/or power limit is determined at step 1310, instructions are sent at step 1312 to the driveline system 200. For example, the speed limit may be sent to an ESC connected to the motor unit 110, or directly to the motor unit.

The method 1300 ensures safe and efficient operation of the driveline system 200, as the maximum speed and/or power consumption of the watercraft 100 is determined based on relevant operational parameters. The method 1300 may be performed during operation of the watercraft 100, for example periodically, to ensure that none of the measured parameters discussed above have changed during operation.

In some implementations, the control unit 500 of the interface module 300 or the control unit 900 of the battery module 400 may be configured to manage the distribution of power consumption from the batteries of the electric power system 106. The method may be implemented using the software program discussed above. For example, when the charge remaining in each battery is determined at step 1308, the control units 500, 900 may determine which batteries have more charge remaining than others. The power that is drawn from each battery may then be altered proportionally to the remaining charge. For example, more power may be drawn from batteries having more charge remaining that from batteries having less charge.

As discussed above, only one control unit 500, 900 may be required. That is to say, the steps of methods 1200 and 1300 may be performed only in the control unit 500 of the interface module 300 or the control unit 900 of the battery module 400. In implementations where more than one battery module 400 is connected in the driveline system 200, one battery module may act as a master module while other battery modules 400 act as slave modules. Therefore, only the control unit 900 of the master battery module 400 may perform the steps of methods 1200 and 1300.

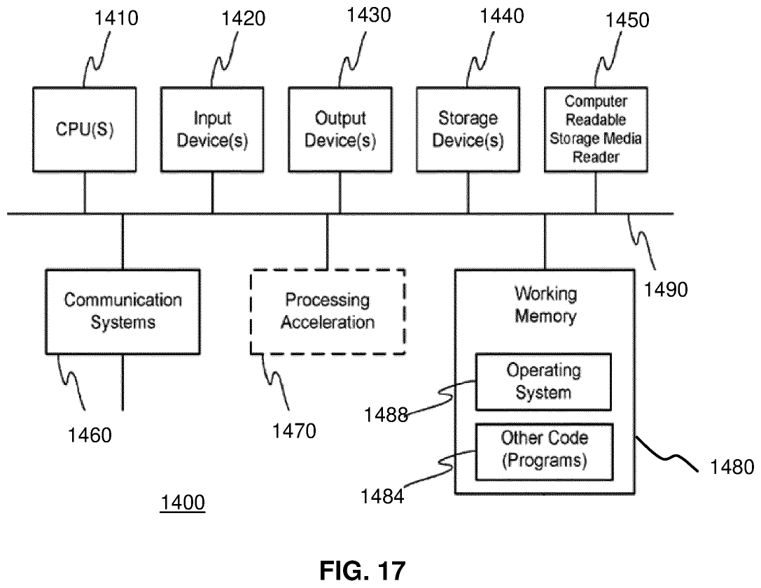

FIG. 17 is a block diagram illustrating an exemplary computer system 1400. This example illustrates a computer system 1400 such as may be used, in whole, in part, or with various modifications, to provide the functions of the disclosed system, for example in the control units 500, 900. For example, various functions may be controlled by the computer system 1400, including, merely by way of example, checking, determining, sending, etc.

The computer system 1400 is shown comprising hardware elements that may be electrically coupled via a bus 1490. The hardware elements may include one or more central processing units 1410, one or more input devices 1420 (e.g., a mouse, a keyboard, etc.), and one or more output devices 1430 (e.g., a display device, a printer, etc.). The computer system 1400 may also include one or more storage devices 1440. By way of example, the storage devices 1440 may be disk drives, optical storage devices, solid-state storage device such as a random-access memory (“RAM”) and/or a read-only memory (“ROM”), which can be programmable, flash-updateable and/or the like.

The computer system 1400 may additionally include a computer-readable storage media reader 1450, a communications system 1460 (e.g., a modem, a network card (wireless or wired), an infra-red communication device, Bluetooth™ device, cellular communication device, etc.), and a working memory 1480, which may include RAM and ROM devices as described above. In some embodiments, the computer system 1400 may also include a processing acceleration unit 1470, which can include a digital signal processor, a special-purpose processor and/or the like.

The computer-readable storage media reader 1450 can further be connected to a computer-readable storage medium, together (and, optionally, in combination with the storage devices 1440) comprehensively representing remote, local, fixed, and/or removable storage devices plus storage media for temporarily and/or more permanently containing computer-readable information. The communications system 1460 may permit data to be exchanged with a network, system, computer and/or other component described above.

The computer system 1400 may also comprise software elements, shown as being currently located within the working memory 1480, including an operating system 1488 and/or other code 1484. It should be appreciated that alternative embodiments of a computer system 1400 may have numerous variations from that described above. For example, customised hardware might also be used and/or particular elements might be implemented in hardware, software (including portable software, such as applets), or both. Furthermore, connection to other computing devices such as network input/output and data acquisition devices may also occur.

Software of the computer system 1400 may include code 1484 for implementing any or all of the function of the various elements of the architecture as described herein. For example, software, stored on and/or executed by a computer system such as the system 1400, can provide the functions of the disclosed system. Methods implementable by software on some of these components have been discussed above in more detail.

According to an aspect, a connector system, a driveline system, a modular watercraft, an interface module, a battery module, a control system and method is provided according to the following clauses.

1. An electrical connector system for a modular watercraft comprising:
a first connector comprising a plurality of electrically conductive pins; and
a second connector comprising a plurality of electrically conductive female terminals; wherein each electrically conductive pin and a corresponding one of electrically conductive female terminals are configured to mate when the first connector and the second connector are connected to each other to provide a respective electrically conductive connection; and the electrical connector system comprises at least one sealing means configured to provide a seal around a subset of the electrically conductive connections when the first connector and the second connector are connected to each other.

2. The electrical connector system of clause 1, wherein the sealing means comprises:
at least one O-ring disposed in one of the first connector; and
at least one channel disposed in the second connector;
wherein the O-ring and the channel are configured to interact and provide the seal when the first and second connectors are connected to each other.

3. The electrical connector system of clause 2, wherein:
a respective O-ring is disposed around each of the plurality of electrically conductive pins and a respective channel is disposed around each of the plurality of electrically conductive female terminals.

4. The electrical connector system of any preceding clause, wherein the electrically conductive connections are configured to transfer power and/or data between the first connector and the second connector.

5. The electrical connector system of any preceding clause, wherein:
the plurality of electrically conductive pins comprises a first set of electrically conductive pins and a second set of electrically conductive pins;
the plurality of electrically conductive female terminals comprises a first set of electrically conductive female terminals and a second set of electrically conductive female terminals;
each of the first set of electrically conductive pins and a corresponding one of the first set of electrically conductive female terminals are configured to provide a respective first electrically conductive connection when the first connector and the second connector are connected to each other;
each of the second set of electrically conductive pins and a corresponding one of the second set of electrically conductive female terminals are configured to provide a respective second electrically conductive connection when the first connector and the second connector are connected to each other;
the first electrically conductive connections are configured to transfer power between the first connector and the second connector; and
the second electrically conductive connections are configured to transfer data between the first connector and the second connector.

6. The electrical connector system of any preceding clauses, wherein the first connector and the second connector are configured to provide a blind mate connection with each other.

7. The electrical connector system of any preceding clause, wherein the first connector and the second connector are configured to provide a mechanical connection.

8. The electrical connector system of clause 7, wherein the mechanical connection is a releasable mechanical connection.

9. The electrical connector system of any preceding clause, wherein:
the first connector is coupled to a driveline module of the modular watercraft; and
the second connector is coupled to an electric power module of the modular watercraft.

10. The electrical connector system of clause 9, wherein the first connector is disposed in an interface module of the driveline module.

11. The electrical connector system of clause 9 or 10, wherein the second connector is disposed in a battery module of the electric power module.

12. A driveline system for a modular watercraft comprising:
a driveline module comprising propulsion means for the watercraft, the driveline module comprising a first connector as defined in clauses 1 to 11;
an electric power module comprising a power source for the driveline module, the electric power module comprises a second connector as defined in clauses 1 to 11.

13. A modular watercraft comprising:
a hull module comprising a hull of a hydrofoiling watercraft, hydroplane, surfboard, jet ski, water scooter, inflatable craft, overwater drone, underwater drone, submarine, or boat and;
the driveline system of clause 12.

14. The modular watercraft of clause 13, wherein the hull module comprises a through hole adapted to receive the first connector and/or the second connector.

15. The modular watercraft of clause 14, wherein the through hole is configured to allow water to pass through during operation of the watercraft in order to cool at least part of the driveline module and/or electric power module.

16. An interface module fora driveline module of a modular watercraft, the interface module comprising:
at least one connector configured to provide a plurality of electrically conductive connections to a second module of the modular watercraft; wherein:
the plurality of electrically conductive connections is configured to transfer power and/or data between the interface module and the second module; and
the at least one connector comprises at least one first sealing means configured to provide a seal around a subset of the electrically conductive connections when the connector is connected to the second module.

17. The interface module of clause 16, wherein the sealing means comprises:
at least one O-ring disposed in the connector and configured to interact with at least one corresponding channel of the second module and provide the seal when the connector is connected to the second module.

18. The interface module of clause 16 or 17, wherein the connector comprises a plurality of electrically conductive pins configured to mate with a corresponding plurality of electrically conductive female terminals of the second module to provide the plurality of electrically conductive connections between the interface module and the second module when the first connector is connected to the second module.

19. The interface module of clause 18, wherein the plurality of electrically conductive pins comprises:
a first set of electrically conductive pins configured to transfer power between the interface module and the second module; and
a second set of electrically conductive pins configured to transfer data between the interface module and the second module.

20. The interface module of clause 18 or 19, wherein:
a respective O-ring is disposed around each of the plurality of electrically conductive pins and configured to interact with at least one corresponding channel of the second module and provide the seal when the connector is connected to the second module.

21. The interface module of any of clauses 16 to 20, wherein the second module is an electric power module or a motor unit of the modular watercraft.

22. The interface module of clause 21, wherein the at least one connector comprises:
a first connector configured to provide at least one electrically conductive connection to an electric power module of the modular watercraft; and
a second connector configured to provide at least one electrically conductive connection to a motor unit of the modular watercraft.

23. A battery module fora modular watercraft, the battery module comprising:
a housing comprising an electrical power source; and
a connector disposed on the housing and configured to provide a plurality of electrically conductive connections to a driveline module of the modular watercraft; wherein:
the plurality of electrically conductive connections is configured to transfer power between the electrical power source and the driveline module; and
the at connector comprises at least one first sealing means configured to provide a seal around a subset of the electrically conductive connections when the connector is connected to the driveline module.

24. The battery module of clause 23, wherein the sealing means comprises:
at least one channel disposed in the connector and configured to interact with at least one corresponding O-ring of the driveline module and provide the seal when the connector is connected to the driveline module.

25. The battery module of clause 23 or 24, wherein the connector comprises a plurality of electrically conductive female terminals configured to mate with a corresponding plurality of electrically conductive pins of the driveline module to provide the plurality of electrically conductive connections between the battery module and the driveline module when the connector is connected to the driveline module.

26. The battery module of clause 25, wherein the plurality of electrically conductive female terminals comprises:
a first set of electrically conductive female terminals configured to transfer power between the battery module and the driveline module; and
a second set of electrically conductive female terminals configured to transfer data between the battery module and the driveline module.

27. The battery module of clause 25 or 26, wherein:
a respective channel is disposed around each of the plurality of electrically conductive female terminals and configured to interact with at least one corresponding O-ring of the driveline module and provide the seal when the connector is connected to the driveline module.

28. The battery module of any of clauses 23 to 27, wherein the electrical power source comprises one or more electrochemical cells configured to store energy.

29. The battery module of clause 28, wherein the electrochemical cells are rechargeable.

30. The battery module of clause 28 or 29, further comprising a heat-conducting material disposed between the electrochemical cells and the housing.

31. The battery module of any of clauses 23 to 30, further comprising a second connector configured to provide an electrical connection between the battery module and another battery module.

32. A control system for a modular watercraft comprising a driveline module and an electric power module, the control system comprising:
a control unit disposed in the driveline module or the electric power module; and one or more sensors disposed in the driveline system or the electric power module, the one or more sensors being communicatively coupled to the control unit and configured to detect one more parameters relating to the driveline module or the electric power module;
wherein the control unit is configured to receive information from the one or more sensors and generate a control signal for the driveline module and/or the electric power module based on the received information.

33. The control system of clause 32, wherein the one or more sensors comprise at least one of:
one or more temperature sensors;
one or more moisture sensors;
one or more pressure sensors;
one or more gyroscopes;
one or more magnetic field sensors; and
a voltage sensor.

34. The control system of clause 33, wherein the one or more temperature sensors is configured to detect the temperature in a connection between the driveline module and the electric power module.

35. The control system of clause 33 or 34, wherein the one or more moisture sensors is configured to detect moisture in a connection between the driveline module and the electric power module.

36. The control system of any of clauses 33 to 35, wherein the one or more pressure sensors is configured to detect a pressure indicative of a depth of the driveline module or the electric power module.

37. The control system of any of clauses 36 to 36, wherein the one or more gyroscopes sensors is configured to detect an orientation of the driveline module or the electric power module.

38. The control system of any of clauses 33 to 37, further comprising one or more magnets, wherein the one or more magnetic field sensors are configured to detect a magnetic field from a corresponding magnet.

39. The control system of clause 38, wherein the one or more magnetic field sensors are disposed in the driveline module, and the one or more magnets are disposed in the electric power module.

40. The control system of clause 38 or 39, wherein the one or more magnetic field sensors are disposed in the electric power module, and the one or more magnets are disposed in the driveline module.

41. The control system of any of clauses 33 to 40, wherein the voltage sensor is configured to determine a voltage level of a power source in the electric power module.

42. The control system of any of clauses 32 to 41, wherein the control unit is disposed in the driveline module.

43. The control system of any of clauses 32 to 41, wherein the control unit is disposed in the electric power module.

44. The control system of any of clauses 32 to 43, wherein the control signal includes an instruction relating to activation of the electric power module.

45. The control system of any of clauses 32 to 43, wherein the control signal includes a speed limit and/or power for operation of the driveline module.

46. The control system of clause 45, wherein the control unit is configured to provide the control signal to an electronic speed controller of the driveline module.

47. A method for controlling activation of a driveline system of a modular watercraft, wherein the driveline system comprises a driveline module and an electric power module, the method the method performed by a control unit of the modular watercraft and comprising:
determining if one or more conditions for activation of the driveline system have been met; if it is determined that the conditions for activation of the driveline system have been met, providing instructions enabling activation of the driveline module.

48. The method of clause 48, wherein determining if one or more conditions for activation of the driveline system have been met comprises at least one of:
determining a temperature in the driveline system and comparing the determined temperature to at least one temperature threshold;
determining a moisture level in the driveline system and comparing the determined moisture level to at least one moisture threshold;
determining a pressure of the driveline system and comparing the determined pressure to at least one pressure threshold;
determining an orientation of the driveline system and comparing the determined orientation to desired orientation;
determining a proximity between the driveline module and the electric power module and comparing the determined proximity to at least one proximity threshold; and
determining a voltage level of a power source in the electric power module and comparing the determined voltage level to at least one voltage threshold.

49. The method of clause 47 or 48, further comprising, if it is determined that one or more of the conditions for activation of the driveline system has not been met, providing instructions prohibiting activation of the driveline system or shutting down the driveline system.

50. The method of any of clauses 47 to 49, further comprising, if it is determined that one or more of the conditions for activation of the driveline system has not been met, issuing an alert indicating that the driveline system should not be activated or should be shut down.

51. The method of any of clauses 47 to 50, wherein the method is performed before start-up of the driveline module.

52. The method of any of clauses 47 to 50, wherein the method is performed during operation of the driveline module.

53. The method of any of clauses 47 to 52, wherein the control unit is disposed in the driveline module or the electric power module.

54. A method for controlling operation of a modular watercraft, wherein the modular watercraft comprises a hull module, a driveline module and an electric power module, the method performed by a control unit of the modular watercraft and comprising:
determining at least one operating condition of the watercraft, including at least one of: determining the type of the hull module;
determining the depth of modular watercraft;
determining the number of batteries in the electric power module; and determining a level of charge remaining in the batteries;
determining a maximum speed and/or power for the modular watercraft based on the at least one determined operating condition;
generating a control signal for the driveline module indicating a maximum speed and/or power at which the driveline module may operate.

55. The method of clause 54, wherein the type of hull module is determined based on a user input to the modular watercraft.

56. The method of clause 54 or 55, wherein the depth of modular watercraft is determined based on a signal received from a pressure sensor disposed in the modular watercraft.

57. The method of any of clauses 54 to 56, wherein the number of batteries in the electric power module is determined based on a signal received from the electric power module.

58. The method of any of clauses 54 to 57 wherein the level of charge remaining in the batteries is determined based on a signal received from the electric power module.

59. The method of any of clauses 54 to 58, further comprising transmitting the control signal to an electronic speed controller of the driveline module.

60. The method of any of clauses 54 to 59, wherein the control unit is disposed in the driveline module or the electric power module.

As used herein, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second”, etc. do not preclude a plurality. Reference signs in the claims are provided merely as a clarifying example and shall not be construed as limiting the scope of the claims in any way.

1. An electrical connector system for a modular watercraft, the electrical connector system comprising:
a first connector including a plurality of electrically conductive pins; and
a second connector including a plurality of electrically conductive female terminals;
wherein each electrically conductive pin and a corresponding one of electrically conductive female terminals are configured to mate when the first connector and the second connector are connected to each other to provide a respective electrically conductive connection; and
wherein the electrical connector system includes sealing means for providing a seal around a subset of the electrically conductive connections when the first connector and the second connector are connected to each other.

2. The electrical connector system of claim 1, wherein the sealing means comprises:
at least one O-ring disposed in one of the first connector and the second connector; and
at least one channel disposed in the second connector;
wherein the O-ring and the channel are configured to interact and provide the seal when the first and the second connectors are connected to each other.

3. The electrical connector system of claim 2,
wherein a respective O-ring is disposed around each of the plurality of electrically conductive pins and a respective channel is disposed around each of the plurality of electrically conductive female terminals.

4. The electrical connector system of claim 1, wherein the electrically conductive connections are configured to transfer power and/or data between the first connector and the second connector.

5. The electrical connector system of claim 1, wherein the electrical connector system is configured to transfer power and data between the first connector and the second connector.

6. The electrical connector system of claim 1, wherein the plurality of electrically conductive pins comprises a first set of electrically conductive pins and a second set of electrically conductive pins;
wherein the plurality of electrically conductive female terminals comprises a first set of electrically conductive female terminals and a second set of electrically conductive female terminals;
wherein each of the first set of electrically conductive pins and a corresponding one of the first set of electrically conductive female terminals are configured to provide a respective first electrically conductive connection when the first connector and the second connector are connected to each other;
wherein each of the second set of electrically conductive pins and a corresponding one of the second set of electrically conductive female terminals are configured to provide a respective second electrically conductive connection when the first connector and the second connector are connected to each other;
wherein the first electrically conductive connections are configured to transfer power between the first connector and the second connector; and
wherein the second electrically conductive connections are configured to transfer data between the first connector and the second connector.

7. The electrical connector system of claim 1, wherein the first connector and the second connector are configured to provide a blind mate connection with each other.

8. The electrical connector system of claim 1, wherein the first connector and the second connector are configured to provide a mechanical connection.

9. The electrical connector system of claim 8, wherein the mechanical connection is a releasable mechanical connection.

10. The electrical connector system of claim 1, wherein one of the first connector and the second connector is coupled to a driveline module of the modular watercraft; and
Wherein the other of first connector and the second connector is coupled to an electric power module of the modular watercraft.

11. The electrical connector system of claim 10, wherein the first connector or the second connector is disposed in an interface module of the driveline module.

12. The electrical connector system of claim 10, wherein the first connector or the second connector is disposed in a battery module of the electric power module.

13. A driveline system for a modular watercraft, the driveline system comprising:
a driveline module including propulsion means for the watercraft, the driveline module including a first connector according to claim 1;
an electric power module including a power source for the driveline module, the electric power module including a first connector or a second connector according to claim 1.

14. A modular watercraft comprising:
a hull module including a hull of a hydrofoiling watercraft, hydroplane, surfboard, jet ski, water scooter, inflatable craft, overwater drone, underwater drone, submarine, or boat; and
the driveline system of claim 13.

15. The modular watercraft of claim 14, wherein the hull module comprises a through hole adapted to receive the first connector and/or the second connector.

16. The modular watercraft of claim 15, wherein the through hole is configured to allow water to pass through during operation of the watercraft in order to cool at least part of the driveline module and/or the electric power module.

17. An interface module for a driveline module of a modular watercraft, the interface module comprising:
a connector configured to provide a plurality of electrically conductive connections to a second module of the modular watercraft;
wherein the plurality of electrically conductive connections is configured to transfer power and/or data between the interface module and the second module; and
wherein the connector includes sealing means for providing a seal around a subset of the electrically conductive connections when the connector is connected to the second module.

18. The interface module of claim 17, wherein the sealing means comprises:
at least one O-ring disposed in the connector and configured to interact with at least one corresponding channel of the second module and provide the seal when the connector is connected to the second module.

19. The interface module of claim 18, wherein the connector comprises a plurality of electrically conductive pins configured to mate with a corresponding plurality of electrically conductive female terminals of the second module to provide the plurality of electrically conductive connections between the interface module and the second module when the connector is connected to the second module.

20. The interface module of claim 19, wherein the plurality of electrically conductive pins comprises:
a first set of electrically conductive pins configured to transfer power between the interface module and the second module; and
a second set of electrically conductive pins configured to transfer data between the interface module and the second module.

21. The interface module of claim 19, wherein a respective O-ring is disposed around each of the plurality of electrically conductive pins and configured to interact with at least one corresponding channel of the second module and provide the seal when the connector is connected to the second module.

22. The interface module of claim 17, wherein the second module is an electric power module or a motor unit of the modular watercraft.

23. The interface module of claim 22, wherein the connector comprises:
a first connector configured to provide at least one electrically conductive connection to an electric power module of the modular watercraft; and
a second connector configured to provide at least one electrically conductive connection to a motor unit of the modular watercraft.

24. A battery module for a modular watercraft, the battery module comprising:
a housing including an electrical power source; and
a connector disposed on the housing and configured to provide a plurality of electrically conductive connections to a driveline module of the modular watercraft;
wherein the plurality of electrically conductive connections is configured to transfer power between the electrical power source and the driveline module; and
wherein the connector includes sealing means for providing a seal around a subset of the electrically conductive connections when the connector is connected to the driveline module.

25. The battery module of claim 24, wherein the sealing means comprises:
at least one channel disposed in the connector and configured to interact with at least one corresponding O-ring of the driveline module and provide the seal when the connector is connected to the driveline module.

26. The battery module of claim 24, wherein the connector comprises a plurality of electrically conductive female terminals configured to mate with a corresponding plurality of electrically conductive pins of the driveline module to provide the plurality of electrically conductive connections between the battery module and the driveline module when the connector is connected to the driveline module.

27. The battery module of claim 26, wherein the plurality of electrically conductive female terminals comprises:
a first set of electrically conductive female terminals configured to transfer power between the battery module and the driveline module; and
a second set of electrically conductive female terminals configured to transfer data between the battery module and the driveline module.

28. The battery module of claim 26, wherein a respective channel is disposed around each of the plurality of electrically conductive female terminals and configured to interact with at least one corresponding O-ring of the driveline module and provide the seal when the connector is connected to the driveline module.

29. The battery module of claim 24, wherein the electrical power source comprises one or more electrochemical cells configured to store energy.

30. The battery module of claim 29, wherein the electrochemical cells are rechargeable.

31. The battery module of claim 29, further comprising a heat-conducting material disposed between the electrochemical cells and the housing.

32. The battery module claim 24, further comprising a second connector configured to provide an electrical connection between the battery module and another battery module.

33.-81. (canceled)
